(19) United States
(12) Patent Application Publication
(10) Pub. No.: US 2025/0360911 A1
(43) Pub. Date: Nov. 27, 2025

(54) CONTROL METHODS AND DEVICES FOR ELECTRIC MOBILE DEVICES

(71) Applicant: SHENZHEN ZHIMAHUAERKAI TECHNOLOGY CO., LTD., Shenzhen (CN)

(72) Inventor: Jianjian ZENG, Shenzhen (CN)

(73) Assignee: SHENZHEN ZHIMAHUAERKAI TECHNOLOGY CO., LTD., Shenzhen (CN)

(21) Appl. No.: 19/295,671

(22) Filed: Aug. 10, 2025

Related U.S. Application Data
(63) Continuation-in-part of application No. PCT/CN2024/076840, filed on Feb. 8, 2024.

(30) Foreign Application Priority Data
Feb. 10, 2023 (CN) 202310131250.8
Feb. 10, 2023 (CN) 202310154357.4

(51) Int. Cl. B60W 20/50; B60W 20/14; B60W 30/14; B60W 30/18; B60W 30/188

(52) U.S. Cl. CPC B60W 20/50; B60W 20/14; B60W 30/146; B60W 30/18072; B60W 30/18127; B60W 30/1884; B60W 2510/081; B60W 2510/083; B60W 2510/085; B60W 2520/105; B60W 2552/15

(57) ABSTRACT

Disclosed herein is a control device for an electric mobile device. The control device includes a measurement unit and a processor, the measurement unit being electrically connected to the processor. The processor is configured to: acquire operational data of the electric mobile device via the measurement unit; determine an operation condition estimation of the electric mobile device based on the operational data; determine a target control strategy corresponding to the operation condition estimation; and control the electric mobile device to perform a corresponding operation according to the target control strategy. By determining the operation condition estimation based on the operational data of the electric mobile device, and determining the target control strategy based on the operation condition estimation, the control effect of the operation of the electric mobile device is more targeted, the control effect and the operation condition estimation of the matching of the improvement.

### CROSS-REFERENCE

This application is a continuation-in-part of PCT application No. PCT/CN2024/076840, filed on Feb. 8, 2024, which claims priority to Chinese Application No. 202310131250.8 filed on Feb. 10, 2023 and priority to Chinese Application No. 202310154357.4 filed on Feb. 10, 2023, the entire contents of each of which are incorporated herein by reference.

### TECHNICAL FIELD

The present disclosure relates to the field of device control technology, and in particular relates to a control method and a device for an electric mobile device.

### BACKGROUND

Electric mobile devices provide a great deal of convenience for people's daily life. The control of electric mobile devices is closely related to the safety performance of these devices, and the control effect also affects the user experience of these devices. Users may inevitably encounter ramps, curves, and other scenarios when travelling with their electric mobile devices. In the realization of the current control technology, there is a lack of consideration for the use of different scenarios, which leads to a lack of experience in the use of electric mobile devices, and there is a large room for improvement. And the safety performance of the electric mobile devices also needs to be further improved.

Therefore, it is desired to provide a control method, and a device for an electric mobile device to enhance the safety performance of the electric mobile devices and to improve the user experience.

### SUMMARY

One or more embodiments of the present disclosure provide a control device for an electric mobile device, including a measurement unit and a processor. The measurement unit is electrically connected to the processor; and the processor may be configured to: acquire operational data of the electric mobile device via the measurement unit; determine an operation condition estimation of the electric mobile device based on the operational data; determine a target control strategy corresponding to the operation condition estimation; generate a control instruction based on the target control strategy; and control the electric mobile device to perform a corresponding operation according to the target control strategy.

In some embodiments, the processor may be further configured to: in response to the operation condition estimation of the electric mobile device being a first operation condition, determine the target control strategy including determining a control output quantity of a drive component of the electric mobile device at a next time under the first operation condition based on an operating mode of the drive component at a current time; and in response to the operation condition estimation being a second operation condition, determine the target control strategy including: acquiring reference data corresponding to the second operation condition; and determining the control output quantity of the drive component at the next time under the second operation condition based on the reference data and a preset rule.

In some embodiments, the operational data includes a target speed of the electric mobile device; the first operation condition includes a braking condition; and the processor may be further configured to: in response to the drive component being in an operating mode of returning braking energy to a power source of the electric mobile device at the current time, determine the control output quantity of the drive component at the next time under the braking condition based on a control output quantity error of the drive component, the control output quantity error being a difference between a current control output quantity of the drive component and a target control output quantity of the drive component; and in response to the drive component not being in the operating mode of returning braking energy to the power source of the electric mobile device at the current time, determine the control output quantity of the drive component at the next time under the braking condition based on a braking reference value.

In some embodiments, the braking reference value includes an actual acceleration of the electric mobile device at the current time; and the processor may be further configured to: determine an acceleration of the control output quantity of the drive component under the braking condition based on the actual acceleration of the electric mobile device at the current time; and determine a sum of the acceleration of the control output quantity of the drive component under the braking condition and the current control output quantity of the drive component as the control output quantity of the drive component at the next time under the braking condition.

In some embodiments, the operational data further includes an actual rotation speed of the drive component; and the processor may be further configured to: determine a distance variation value of the electric mobile device under the braking condition based on the actual rotation speed of the drive component, the braking reference value including the distance variation value; determine an acceleration of the control output quantity of the drive component under the braking condition based on the distance variation value; and determine a sum of the acceleration of the control output quantity of the drive component under the braking condition and the current control output quantity of the drive component as the control output quantity of the drive component at the next time under the braking condition.

In some embodiments, the operational data includes an actual output torque of the drive component and an actual input voltage of the drive component; the second operation condition includes a coasting condition; and the processor may be further configured to: determine a target input voltage required for the actual output torque of the drive component based on the actual output torque of the drive component; and in response to the target input voltage being greater than the actual input voltage of the drive component, determine that the operation condition estimation of the electric mobile device is the coasting condition.

In some embodiments, the operational data may include a target speed of the electric mobile device, and an actual rotation speed of the drive component, and the processor may be further configured to: in response to the target speed of the electric mobile device and the actual rotation speed of the drive component having different directions, determine that the operation condition estimation of the electric mobile device is the coasting condition

In some embodiments, the reference data includes a coasting reference value, the coasting reference value includes the actual output torque of the drive component; and the processor may be further configured to: determine a target input voltage required for the actual output torque of the drive component based on the actual output torque of the drive component; determine an acceleration of the control output quantity of the drive component under the coasting condition based on a difference between the target input voltage and an actual input voltage corresponding to the current control output quantity of the drive component; and determine a sum of the acceleration of the control output quantity of the drive component under the coasting condition and the current control output quantity of the drive component as the control output quantity of the drive component at the next time under the coasting condition.

In some embodiments, the operational data includes at least two of a target speed of the electric mobile device, an actual output torque of the drive component, and an actual rotation speed of the drive component; the second operation condition includes an overspeed condition; and the processor may be further configured to: in response to the actual output torque of the drive component and the actual rotation speed of the drive component having different directions, determine that the operation condition estimation of the electric mobile device is the overspeed condition; or in response to the target speed of the electric mobile device and the actual rotation speed of the drive component having a same direction, determine that the operation condition estimation of the electric mobile device is the overspeed condition.

In some embodiments, the reference data includes an overspeed reference value, the overspeed reference value includes the actual output torque of the drive component; and the processor may be further configured to: determine a target input voltage required for the actual output torque of the drive component based on the actual output torque of the drive component; determine an acceleration of the control output quantity of the drive component under the overspeed condition based on a difference between the target input voltage and an actual input voltage corresponding to the current control output quantity of the drive component; and determine a sum of the acceleration of the control output quantity of the drive component under the overspeed condition and the current control output quantity of the drive component as the control output quantity of the drive component at the next time under the overspeed condition.

In some embodiments, the overspeed reference value further includes a current overspeed value of the electric mobile device; and the processor is further configured to: determine an acceleration of the control output quantity of the drive component under the overspeed condition based on the current overspeed value of the electric mobile device; and determine a sum of the acceleration of the control output quantity of the drive component under the overspeed condition and the current control output quantity of the drive component as the control output quantity of the drive component at the next time under the overspeed condition.

In some embodiments, the operational data includes at least two of a target speed of the electric mobile device, an actual output torque of the drive component, and an actual rotation speed of the drive component; the second operation condition includes a free deceleration condition; and the processor may be further configured to: in response to the actual output torque of the drive component and the actual rotation speed of the drive component having a same direction, determine that the operation condition estimation of the electric mobile device is the free deceleration condition; or, in response to the target speed of the electric mobile device and the actual rotation speed of the drive component having a same direction, determine that the operation condition estimation of the electric mobile device is the free deceleration condition.

In some embodiments, the reference data includes a free deceleration reference value, the free deceleration reference value includes a control output quantity error of the drive component; and the processor may be further configured to: determine an acceleration of the control output quantity of the drive component under the free deceleration condition based on the control output quantity error of the drive component, the control output quantity error being a difference between a current control output quantity of the drive component and a target control output quantity of the drive component; and determine a sum of the acceleration of the control output quantity of the drive component under the free deceleration condition and the current control output quantity of the drive component as the control output quantity of the drive component at the next time under the free deceleration condition.

In some embodiments, the free deceleration reference value further includes a difference between the actual rotation speed of the drive component and the target speed of the electric mobile device; and the processor may be further configured to: determine an acceleration of the control output quantity of the drive component under the free deceleration condition based on the difference between the actual rotation speed of the drive component and the target speed of the electric mobile device; and determine a sum of the acceleration of the control output quantity of the drive component under the free deceleration condition and the current control output quantity of the drive component as the control output quantity of the drive component at the next time under the free deceleration condition.

In some embodiments, the second operation condition includes a normal driving condition; the reference data includes a normal driving reference value, the normal driving reference value includes a control output quantity error of the drive component; and the processor may be further configured to: determine an acceleration of the control output quantity of the drive component under the normal driving condition based on the control output quantity error of the drive component, the control output quantity error being a difference between a current control output quantity of the drive component and a target control output quantity of the drive component; and determine a sum of the acceleration of the control output quantity of the drive component under the normal driving condition and the current control output quantity of the drive component as the control output quantity of the drive component at the next time under the normal driving condition.

In some embodiments,; the operational data includes an inclination angle of the electric mobile device relative to a horizontal road surface; the operation condition estimation includes a third operation condition, the third operation condition includes a first slope condition, a second slope condition, or a third slope condition; and the processor may be further configured to: in response to the inclination angle being less than a first angle threshold, determine that the operation condition estimation of the electric mobile device is the first slope condition; in response to the inclination angle remaining greater than a second angle threshold and less than a third angle threshold for a first accumulated time exceeding a first time threshold, determine that the operation condition estimation of the electric mobile device is the second slope condition; and in response to the inclination angle remaining greater than the third angle threshold for a second accumulated time exceeding a second time threshold, determine that the operation condition estimation of the electric mobile device is the third slope condition.

In some embodiments, the processor may be further configured to determine the target control strategy including deactivating a voice broadcast device of the electric mobile device for the first slope condition; determine the target control strategy including controlling the voice broadcast device to issue a safety reminder for the second slope condition; determine the target control strategy including controlling the electric mobile device to decelerate for the third slope device.

In some embodiments, a hazard level of the second slope condition may be higher than a hazard level of the first slope condition, and a hazard level of the third slope condition may be higher than the hazard level of the second slope condition.

In some embodiments, the inclination angle includes a forward inclination angle and a lateral inclination angle; and the processor may be further configured to: acquire acceleration information and angular velocity information of the electric mobile device; perform Kalman filter fusion on the acceleration information and the angular velocity information to determine a pitch angle and a roll angle of the electric mobile device; and set the pitch angle as the forward inclination angle and the roll angle as the lateral inclination angle.

In some embodiments, the operational data includes an actual linear speed and an actual angular speed of the electric mobile device; the operation condition estimation includes a fourth operation condition, the fourth operation condition includes a turning overspeed condition; and the processor may be further configured to: determine a turning radius of the electric mobile device based on the actual linear speed and the actual angular speed of the electric mobile device; determine a maximum linear speed of the electric mobile device based on the turning radius; and in response to the actual linear speed being greater than the maximum linear speed, determine that the operation condition estimation of the electric mobile device is the turning overspeed condition, and determine the target control strategy including controlling the electric mobile device to reduce the actual linear speed to below the maximum linear speed.

In some embodiments, the processor may be further configured to: determine the maximum linear speed of the electric mobile device based on a preset centrifugal acceleration and the turning radius; and determine the actual linear speed of the electric mobile device based on acceleration information of the electric mobile device, the actual angular speed of the electric mobile device, a rotation speed of a drive component of the electric mobile device, a reduction ratio, and a wheel diameter parameter of the electric mobile device.

One or more embodiments of the present disclosure provide a control device for slope safety reminder of an electric mobile device. The electric mobile device includes a measurement unit, a voice broadcast device, and a processor, the measurement unit and the voice broadcast device are electrically connected to the processor; and the processor may be configured to: acquire operational data of the electric mobile device via the measurement unit; determine an inclination angle of the electric mobile device based on the operational data; in response to the inclination angle being less than a first angle threshold, deactivate a reminder of the voice broadcast device, clear a first accumulated time and a second accumulated time, and continue acquiring the operational data of the electric mobile device via the measurement unit to determine the inclination angle of the electric mobile device; in response to the inclination angle being greater than the first angle threshold and less than a second angle threshold, continue acquiring the operational data of the electric mobile device via the measurement unit to determine the inclination angle of the electric mobile device; in response to the inclination angle being greater than the second angle threshold and less than a third angle threshold, and the first accumulated time being less than a set time, increment the first accumulated time by 1, and continue acquiring the operational data of the electric mobile device via the measurement unit to determine the inclination angle of the electric mobile device; in response to the inclination angle being greater than the second angle threshold and less than the third angle threshold, and the first accumulated time being greater than the set time, activate the voice broadcast device to issue a reminder; in response to the inclination angle being greater than the third angle threshold, and the second accumulated time being less than the set time, increment the second accumulated time by 1, and continue acquiring the operational data of the electric mobile device via the measurement unit to determine the inclination angle of the electric mobile device; and in response to the inclination angle being greater than the third angle threshold, and the second accumulated time being greater than the set time, control the electric mobile device to decelerate to a stop.

One or more embodiments of the present disclosure provide a control device for intelligent turning deceleration of an electric mobile device. The electric mobile device includes a measurement unit and a processor, the measurement unit is electrically connected to the processor; and the processor may be configured to: acquire operational data of the electric mobile device via the measurement unit, and determine an actual linear speed and an actual angular speed of the electric mobile device based on the operational data; determine a turning radius of the electric mobile device based on the actual linear speed and the actual angular speed of the electric mobile device; determine a maximum linear speed of the electric mobile device based on the turning radius; in response to the actual linear speed of the electric mobile device being less than the maximum linear speed, return to acquiring the operational data of the electric mobile device via the measurement unit to determine the actual linear speed and the actual angular speed of the electric mobile device; and in response to the actual linear speed of the electric mobile device being greater than the maximum linear speed, control the electric mobile device to reduce the actual linear speed to below the maximum linear speed.

### BRIEF DESCRIPTION OF THE DRAWINGS

The present disclosure may be further illustrated by way of exemplary embodiments, which may be described in detail by means of the accompanying drawings. These embodiments are not limiting, and in these embodiments, the same numbering denotes the same structure, wherein:

FIG. 1 is an exemplary schematic diagram illustrating a control device for an electric mobile device according to some embodiments of the present disclosure;

FIG. 2 is an exemplary flowchart illustrating a control process for an electric mobile device according to some embodiments of the present disclosure;

FIG. 3 is an exemplary schematic diagram illustrating a plurality of types of operation conditions of an electric mobile device according to some embodiments of the present disclosure;

FIG. 4 is an exemplary flowchart illustrating a process for determining a target control strategy corresponding to an operation condition according to some embodiments of the present disclosure;

FIG. 5 is an exemplary flowchart illustrating a process for determining a control output quantity of a drive component at a next time under a braking condition based on a braking reference value according to some embodiments of the present disclosure;

FIG. 6 is an exemplary flowchart illustrating a process for determining a control output quantity of a drive component at a next time under a braking condition based on a braking reference value according to some other embodiments of the present disclosure;

FIG. 7 is an exemplary flowchart illustrating a process for determining a control output quantity of a drive component at a next time under a coasting condition based on a coasting reference value and a preset rule according to some embodiments of the present disclosure;

FIG. 8 is an exemplary flowchart illustrating a process for determining a control output quantity of a drive component at a next time under a coasting condition based on a coasting reference value and a preset rule, according to some other embodiments of the present disclosure;

FIG. 9 is an exemplary flowchart illustrating a process for determining a control output quantity of a drive component at a next time under an overspeed condition based on an overspeed reference value and a preset rule, according to some embodiments of the present disclosure;

FIG. 10 is an exemplary flowchart illustrating a process for determining a control output quantity of a drive component at a next time under an overspeed condition based on an overspeed reference value and a preset rule, according to some other embodiments of the present disclosure;

FIG. 11 is an exemplary flowchart illustrating a process for determining a control output quantity of a drive component at a next time under a free deceleration condition based on a free deceleration reference value and a preset rule according to some embodiments of the present disclosure;

FIG. 12 is an exemplary flowchart illustrating a process for determining a control output quantity of a drive component at a next time under a free deceleration condition based on a free deceleration reference value and a preset rule, according to some other embodiments of the present disclosure;

FIG. 13 is an exemplary flowchart illustrating a process for determining a control output quantity of a drive component at a next time under a normal driving condition based on a normal driving reference value and a preset rule, according to some embodiments of the present disclosure;

FIG. 14 is an implementation flowchart illustrating a control method of an electric mobile device having a brushed motor as a drive component according to some embodiments of the present disclosure;

FIG. 15 is an implementation flowchart illustrating a control method of an electric mobile device having a brushless motor as a drive component according to some embodiments of the present disclosure;

FIG. 16 is an exemplary flowchart illustrating a process for determining an operation condition estimation of an electric mobile device based on operational data according to some embodiments of the present disclosure;

FIG. 17 is an implementation flowchart illustrating a method for slope safety reminder of an electric mobile device, according to some embodiments of the present disclosure;

FIG. 18 is a schematic diagram illustrating a structure of a computerized device according to some embodiments of the present disclosure;

FIG. 19 is a block diagram illustrating a specific structure of an electric mobile device according to some embodiments of the present disclosure;

FIG. 20 is an implementation flowchart illustrating a method for intelligent turning deceleration of an electric mobile device according to some embodiments of the present disclosure; and

FIG. 21 is a schematic diagram illustrating an exemplary control system for intelligent turning deceleration of an electric mobile device according to some embodiments of the present disclosure.

### DETAILED DESCRIPTION

In order to more clearly illustrate the technical solutions of the embodiments of the present disclosure, the accompanying drawings required to be used in the description of the embodiments will be briefly described below. Obviously, the accompanying drawings in the following description are only some examples or embodiments of the present disclosure, and it is possible for a person of ordinary skill in the art to apply the present disclosure to other similar scenarios according to these drawings without creative labor. Unless obviously obtained from the context or the context illustrates otherwise, the same numeral in the drawings refers to the same structure or operation.

It should be understood that, as used herein, the terms “system”, “device”, “unit,” and/or “module” are used herein as a way to distinguish between different components, elements, parts, sections, or assemblies at different levels. However, the words may be replaced by other expressions if other words accomplish the same purpose.

As shown in the specification and claims herein, unless the context clearly suggests an exception, the words “a”, “an ”, “one”, and/or “the” do not refer specifically to the singular, but may also include the plural. Generally, the terms “including” and “comprising” only suggest the inclusion of explicitly identified steps and elements that do not constitute an exclusive list, and the method or device may also include other steps or elements.

Flowcharts are used in the present disclosure to illustrate operations performed by a system according to embodiments of the present disclosure. It should be appreciated that the preceding or following operations are not necessarily performed in an exact sequence. Instead, steps may be processed in reverse order or simultaneously. Also, it is possible to add other operations to these processes or remove an operation or operations from them.

An electric mobile device refers to a device that has a capability of being moved under conditions of electrical power supply. The electric mobile device may be a mobility tool such as an electric skateboard, a balance bike, an electric wheelchair, a scooter, or the like. A specific type of electric mobile device is not limited to the embodiments of the present disclosure. The electric mobile device has a drive component and a rotation component. The drive component may be a motor, and the rotation component may be a wheel. A control method of the electric mobile device involved in the embodiments of the present disclosure may be applied in device control technology. The control method is used to manage and control the dynamic operation of the electric mobile device, better fulfilling the functional roles of the electric mobile device in people's daily production and life, while enhancing safety and user experience.

When the electric mobile device moves on the road, the diversity and variability of road surfaces (e.g., flat roads, slopes, curves) may be significant. If the design is inadequate or the pre-considered driving conditions are oversimplified, the motion control (e.g., speed control, direction control) of the electric mobile device may fail to align with expected performance under actual road conditions, which may compromise user handling experience and potentially lead to safety hazards. To circumvent the above problems, some embodiments of the present disclosure propose a control technology for the electric mobile device.

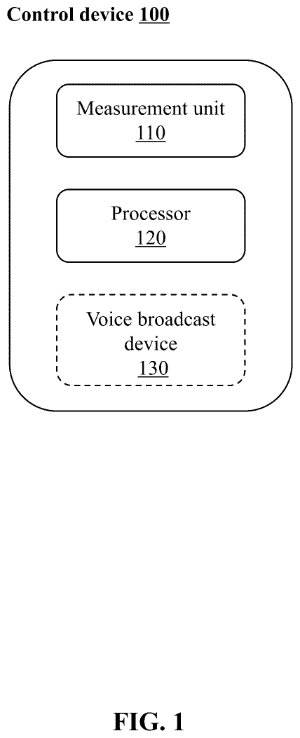

FIG. 1 is an exemplary schematic diagram illustrating a control device for an electric mobile device according to some embodiments of the present disclosure.

Some embodiments of the present disclosure provide the control device for the electric mobile device. As shown in FIG. 1, the control device 100 may include a measurement unit 110 and a processor 120. The measurement unit 110 is electrically connected to the processor 120.

The measurement unit 110 refers to an apparatus or a device for obtaining operational data of the electric mobile device. For example, the measurement unit 110 may include a speed sensor, a torque sensor, a voltage sensor, an inclination sensor, a contact roller encoder, a gyroscope, an accelerometer, or the like, or a combination thereof.

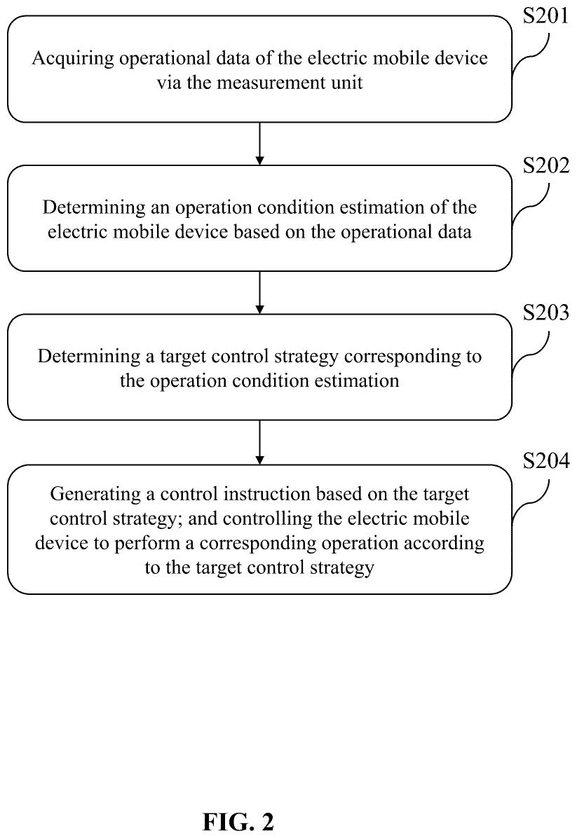

More details regarding the operational data may be found in FIG. 2 and the related descriptions.

The processor 120 may process data and/or information obtained from other devices or system components. The processor 120 may execute program instructions based on the data, information, and/or processing results to perform one or more of the functions described in this application. In some embodiments, the processor 120 may include one or more sub-processing devices (e.g., a single-core processing device or a multi-core multi-chip processing device). Merely by way of example, the processor 120 may include a central processing unit (CPU), a controller, a microcontroller unit, a microprocessor, etc., or any combination thereof.

In some embodiments, the processor 120 may be configured to acquire the operational data of the electric mobile device via the measurement unit, determine an operation condition estimation of the electric mobile device based on the operational data, determine a target control strategy corresponding to the operation condition estimation based on a correspondence relationship between operation conditions and reference control strategies. The correspondence relationship may indicate one of the reference control strategies corresponding to each of the operation conditions. The processor 120 may be further configured to generate a control instruction based on the target control strategy, and control the electric mobile device to perform a corresponding operation according to the target control strategy.

More details regarding the processor may be found in FIG. 2-FIG. 21 and the related descriptions.

In some embodiments, the control device 100 may further include a voice broadcast device 130, and the voice broadcast device 130 may be electrically connected to the processor 120, as shown in FIG. 1.

The voice broadcast device 130 refers to an apparatus or a device for outputting sound, e.g., issuing safety alerts to a user. For example, the voice broadcast device 130 may include a speaker, an intelligent voice broadcast module, an in-vehicle voice broadcast system, or the like.

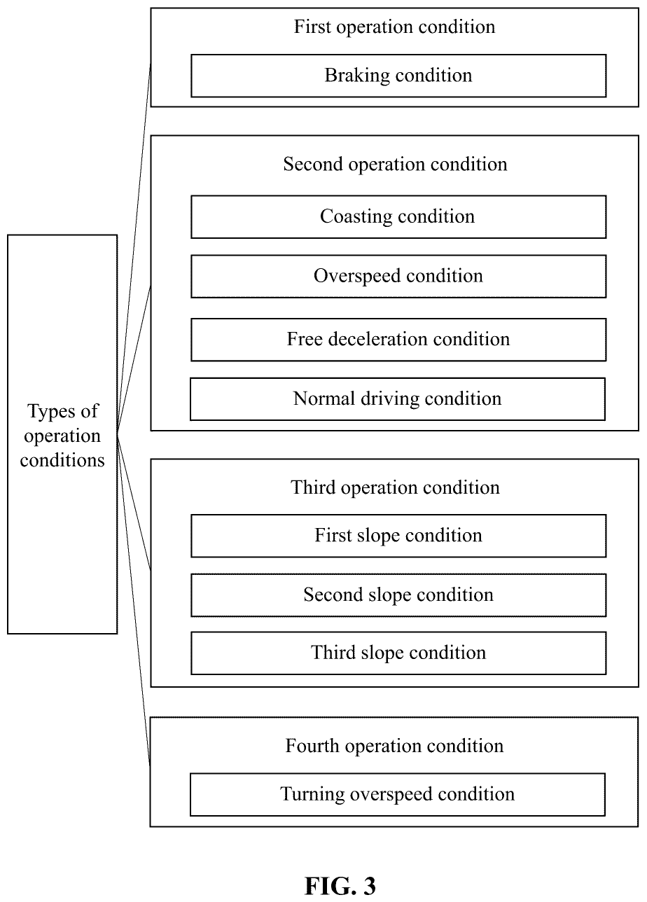

In some embodiments, the voice broadcast device 130 may issue a safety reminder when the electric mobile device is in a second slope condition. More details regarding the second slope condition may be found in the related descriptions later (e.g., FIG. 3).

In some embodiment, at least one of the measurement unit 110, the processor 120, and the voice broadcast device 130 may be integrally provided on the electric mobile device.

FIG. 2 is a flowchart illustrating an exemplary control process for an electric mobile device according to some embodiments of the present disclosure. As shown in FIG. 2, the control process of the electric mobile device includes operations S201-S204. In some embodiments, the control process of the electric mobile device may be performed by the processor 120.

In S201, operational data of the electric mobile device may be acquired by a measurement unit.

The operational data refers to data or information used to characterize the mobility performance of the electric mobile device.

In some embodiments, the operational data of the electric mobile device may include a target speed of the electric mobile device, an actual output torque of a drive component (e.g., a motor), an actual rotation speed of the drive component, an actual input voltage of the drive component, or the like. The target speed refers to a reference speed that an operator expects the electric mobile device achieves in a next control cycle. The actual rotation speed refers to an actual angular speed of the drive component at a current time. The actual input voltage refers to a direct current (DC) bus voltage of a power stage or a phase or line voltage that a driver outputs to the drive component.

In some embodiments, the operational data of the electric mobile device may include an actual inclination angle of the electric mobile device relative to a horizontal road surface. It may be appreciated that the inclination angle of the electric mobile device relative to the horizontal road surface affects the mobility performance of the electric mobile device.

In yet further embodiments, the operational data of the electric mobile device may include an actual linear speed and an actual angular speed of the electric mobile device.

In some embodiments, the operational data of the electric mobile device may be obtained in real time by the measurement unit. It is noted that the operational data of the electric mobile device may also be obtained in any other feasible manner. For example, the target speed of the electric mobile device may be obtained by converting the value of a throttle toggle. As another example, the actual rotation speed of the drive component may be obtained directly by a sensor, such as determining a motor speed by a Hall sensor; or the actual rotation speed of the drive component may be estimated by a software algorithm, such as determining speeds of some motors without position sensors by an observer. As another example, the actual output torque of the drive component is converted from the phase currents of the motor. As yet another example, the actual input voltage of the drive component is obtained by converting the output of a controller of the drive component.

In some embodiments of the present disclosure, by obtaining data information (i.e., the operational data) used to characterize the mobile performance of the electric mobile device, the actual operation condition of the electric mobile device can be determined, which in turn facilitates the execution of a control scheme for the electric mobile device that matches the actual operation condition.

In S202, an operation condition estimation of the electric mobile device may be determined based on the operational data. As used herein, the operation condition estimation refers to an estimation of the actual operation condition of the electric mobile device based on the operational data of the electric mobile device.

The actual operation condition of the electric mobile device may be varied along time. For example, the electric mobile device may be in a first operation condition at a first time, and in a second operation condition at a second time as the driving roadway changes. As another example, the electric mobile device coasts uphill, and does not coast downhill but is running too fast, which also exemplifies the variability of the operation condition. To achieve accurate control of the electric mobile device and to improve user experience, it is critical for some embodiments of the present disclosure to accurately estimate the operation condition of the electric mobile device (i.e., the operation condition estimation). In the embodiments of the present disclosure, the operation condition estimation of the electric mobile device may be determined based on the operational data obtained in operation S101, and since the operational data reflects the current mobile performance of the electric mobile device, the determined operation condition estimation has a certain accuracy.

The processor may determine the operation condition estimation of the electric mobile device in a plurality of ways. In some embodiments, the processor may determine the operation condition estimation of the electric mobile device based on the operational data through an operation condition determination model.

The operation condition determination model refers to a model for estimating the actual operation condition of the electric mobile device, e.g., at the current time. In some embodiments, the operation condition determination model may be a machine learning model. For example, the operation condition determination model may include one or a combination of a Convolutional Neural Network (CNN) model or other customized model.

In some embodiments, the operation condition determination model may be obtained by training a plurality of sets of training samples, each of which has a label. The training samples may include sample operational data. The sample operational data may include one or more of a sample target speed of a sample electric mobile device, a sample output torque of a sample drive component, a sample rotation speed of the sample drive component, a sample actual input voltage of the sample drive component, a sample inclination angle of the sample electric mobile device relative to a horizontal road surface, a sample linear speed and a sample angular speed of the sample electric mobile device, or the like. A label of a training sample may include a reference operation condition corresponding to the training sample.

In some embodiments, the training samples and the labels may be obtained based on historical data.

In some embodiments, the processor may input a plurality of training samples with labels into an initial operation condition determination model, construct a loss function based on each label and an output of the initial operation condition determination model generated based on each training sample, and iteratively update parameters of the initial operation condition determination model based on the loss function by a gradient descent manner or other manners. When a preset condition is met, model training is completed, and a trained operation condition determination model is obtained. The preset condition may be that the loss function converges, a count of iterations reaches a threshold, or the like.

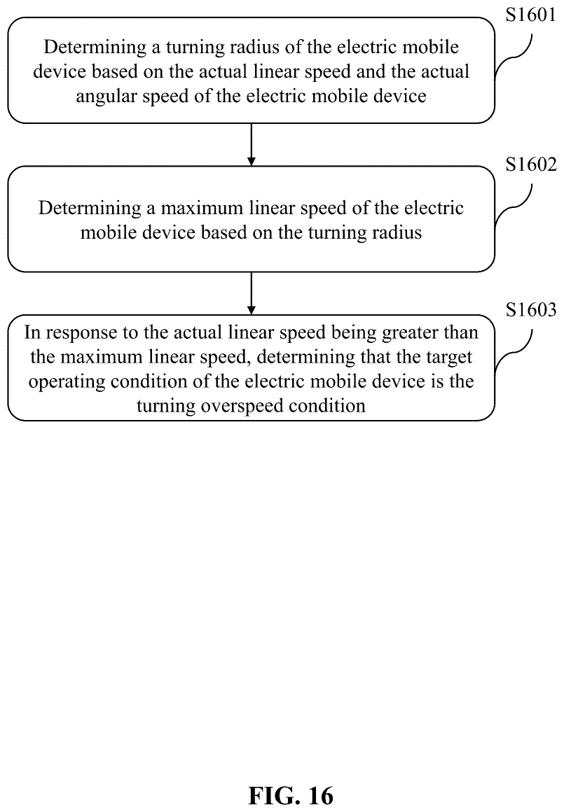

More details regarding how to determine the operation condition estimation of the electric mobile device based on the operational data may be found in the related descriptions later (e.g., FIG. 16).

In S203, a target control strategy corresponding to the operation condition estimation may be determined.

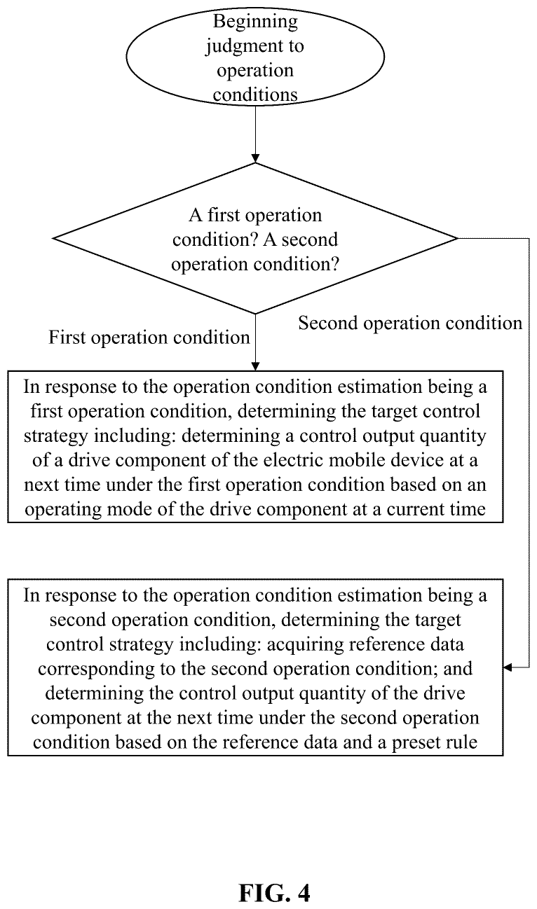

In some embodiments of the present disclosure, the processor may pre-construct a correspondence relationship between the operation conditions and the reference control strategies. For example, an operation condition 1 corresponds to a reference control strategy 1,an operation condition 2 corresponds to a reference control strategy 2, and an operation condition 3 corresponds to a reference control strategy 3. By pre-constructing the correspondence relationship, when the electric mobile device is confirmed to be in a specific operation condition (i.e., the operation condition estimation), the control strategy that matches the operation condition may be determined simply by querying the correspondence relationship. For the convenience of clearly explaining the scheme, the control strategy corresponding to the determined operation condition estimation is referred to as the target control strategy in the embodiments of the present disclosure. More details regarding the target control strategy may be found in the related descriptions later (e.g., FIG. 4).

In S204, a control instruction may be generated based on the target control strategy, and the electric mobile device may be controlled to perform a corresponding operation according to the target control strategy in response to receiving the control instruction.

The control instruction refers to a relevant instruction for controlling the operation of the electric mobile device. For example, the control instruction may include a deceleration instruction, a playback instruction, a stop broadcasting instruction, or the like. In some embodiments, the processor may automatically generate the control instruction based on the target control strategy through a preset program. The preset program may be set up by a technician in advance.

In some embodiments, the processor may send the control instruction to the electric mobile device, and the electric mobile device, in response to receiving the control instruction, performs the corresponding operation based on the target control strategy. For example, the electric mobile device, in response to receiving the stop broadcasting instruction, immediately turns off the voice broadcast device to stop broadcasting.

In other words, after determining the target control strategy via operation S203, the target control strategy may be executed to control the electric mobile device to operate based on the target control strategy. Merely by way of example, if the target control strategy is to uniformly reduce the movement speed of the electric mobile device, a control output quantity of the drive component of the electric mobile device at a next time may be adjusted downward based on the target control strategy.

Some embodiments of the present disclosure provide the control method for the electric mobile device, determining the operation condition estimation based on the operational data of the electric mobile device, and determining the target control strategy based on the operation condition estimation. Thereby, the control effect for the operation of the electric mobile device is more targeted, and the matching of the control effect with the actual operation conditions is improved. The present disclosure avoids the problem of insufficient consideration of the actual operation condition, which leads to an unsatisfactory control effect, and improves the safety of the operation of the electric mobile device under different actual operation conditions, thereby improving the safety experience and the control experience of the electric mobile device of the user.

FIG. 3 is an exemplary schematic diagram illustrating a plurality of types of operation conditions of an electric mobile device according to some embodiments of the present disclosure. As shown in FIG. 3, the operation conditions of an electric mobile device may include a first operation condition, a second operation condition, a third operation condition, and a fourth operation condition. The first operation condition may include a braking condition, an emergency braking condition, or the like. The second operation condition may include a plurality of subdivided operation conditions, which may be referred to herein as second suboperation conditions. Types of the second suboperation conditions include a coasting condition, an overspeed condition, a free deceleration condition, a normal driving condition, or the like. The third operation condition may also include a plurality of subdivided operation conditions, such as a first slope condition, a second slope condition, a third slope condition, or the like. The fourth operation condition includes a turn deceleration operation condition, or the like. It should be noted that FIG. 3 only shows examples of the plurality of types of the operation conditions, and is not intended to be a qualification of the types of the operation conditions the electric mobile device may face.

During acceleration from standstill, the electric mobile device tends to exhibit two extremes: either the start is too gentle or slow, resulting in significant delay and sluggish response; or the start is too abrupt or rapid, causing jerky movement that's difficult to control. And the electric mobile device is also susceptible to speed control effects that deviate from an expected phenomenon when starting uphill and downhill. For example, if a throttle toggle fluctuates very little when starting uphill, the electric mobile device may have a backward coasting phenomenon, and the larger the slope, the larger the backward coasting distance. As another example, when starting downhill, due to gravity on the electric mobile device, the electric mobile device may start faster than on a flat road, and the larger the slope, the more pronounced the feeling of the user of acceleration for the downhill start.

Additionally, a commercially available electric mobile device does not allow for better control of speed during driving, and there is a large variation in speed on roads with large load variations. For example, when going downhill, a vehicle speed may exceed a set speed of the throttle toggle, which gives a sense of downhill acceleration; and the speed going uphill may drop faster, which may give the user the feeling of underpowered for the electric mobile device. Because most of current electric mobile devices are brushed motors with electromagnetic brakes, the electromagnetic brakes may be accessed to hold when the electric mobile devices are braked, and the vehicle may be mostly at a certain speed, resulting in a strong feeling of stuttering at the end of the brake.

The present disclosure can solve the above related problems, so that the users of the electric mobile device can have a corresponding improvement in driving experience.

FIG. 4 is an exemplary flowchart illustrating a process for determining a target control strategy corresponding to an operation condition according to some embodiments of the present disclosure. As shown in FIG. 4, the process for determining the target control strategy corresponding to the operation condition may include in response to the operation condition estimation of an electric mobile device being a first operation condition, determining the target control strategy including: determining a control output quantity of a drive component of the electric mobile device at a next time under the first operation condition based on an operating mode of the drive component at a current time; in response to the operation condition estimation of the electric mobile device being a second operation condition, determining the target control strategy including: acquiring reference data corresponding to the second operation condition; and determining the control output quantity of the drive component at the next time under the second operation condition based on the reference data and a preset rule. As used herein, the current time refers to the time when the operation condition estimation is in or the operational data is acquired. For example, the operational data of the electric mobile device at the current time may be obtained, and the operation condition estimation at the current time may be determined based on the operational data of the electric mobile device.

The operating mode refers to a set of functional states or control strategies operated by the drive component at a certain time (e.g., the current time). For example, the operating mode may include an energy saving mode, a regenerative braking mode, a BOOST mode, or the like.

In some embodiments, the processor may determine the operating mode of the drive component of the electric mobile device at the current time based on the first operation condition by querying a first preset table. The first preset table includes a correspondence relationship between a plurality of sets of the first operation conditions and reference operating modes. For example, the first preset table includes the plurality of sets of the first operation conditions and the reference operating modes corresponding to the plurality of sets of the first operation conditions. In some embodiments, the first preset table may be constructed based on historical data.

The control output quantity refers to a parameter value that is used to control the drive component to perform. For example, the control output quantity may include a voltage, a current, a duty cycle, a pulse width modulation (PWM) period, a torque instruction, a rotation speed, etc.

In some embodiments, the processor may determine the control output quantity of the drive component at the next time under the first operation condition by querying a second preset table based on the operating mode of the drive component of the electric mobile device at the current time. The second preset table includes a correspondence relationship between a plurality of sets of the operating modes and reference control output quantities of the drive component at the next time under the first operation condition. For example, the second preset table may include the plurality of sets of the operating modes and the reference control output quantities of the drive component at the next time under the first operation condition corresponding to the plurality of sets of the operating modes. In some embodiments, the second preset table may be constructed based on historical data.

In some embodiments, in responding to determining that the operation condition estimation is the second operation condition, the processor may determine the control output quantity of the drive component at the next time under the second operation condition based on the reference data and the preset rule.

The reference data refers to a set of real-time or offline baseline parameters used to guide the drive component output. For example, the reference data may include a coasting reference value, an overspeed reference value, a free deceleration reference value, a normal driving reference value, or the like.

In some embodiments, the processor may determine, based on the second operation condition, the reference data corresponding to the second operation condition by querying a third preset table. The third preset table includes a correspondence relationship between a plurality of sets of the second operation conditions and reference data. For example, the third preset table may include the plurality of sets of the second operation conditions and the reference data corresponding to each of the plurality of sets of the second operation conditions. In some embodiments, the third preset table may be set in advance by a technician.

The preset rule refers to a rule for determining the control output quantity of the drive component at the next time in the second operation condition. In some embodiments, the preset rule may be set in advance by a technician based on experience.

More details regarding how to determine the control output quantity of the drive component at the next time under different operation conditions may be described later (e.g., FIG. 4-FIG. 13) in the related descriptions.

Combined with the schematic representation of FIG. 4 and the introduction above, it may be seen that the operation condition estimation directly determines the specific content of the target control strategy. For a scenario in which operation condition estimation is the first operation condition, the content of the target control strategy involves an analysis of the current operating mode of the drive component in the electric mobile device. Using a scenario in which the operation condition estimation is a braking condition in the first operation condition as an example, determining the control output quantity of the drive component in the next time under the first operation condition based on the operating mode of the drive component of the electric mobile device at the current time may include in response to the drive component being in an operating mode of returning braking energy to a power source of the electric mobile device at the current time, determining the control output quantity of the drive component at the next time under the braking condition based on a control output quantity error of the drive component; in response to the drive component not being in the operating mode of returning braking energy to the power source of the electric mobile device at the current time, determining the control output quantity of the drive component at the next time under the braking condition based on a braking reference value.

The control output quantity error of the drive component refers to a difference between a current control output quantity of the drive component and a target control output quantity of the drive component. The current control output quantity refers to an actual control output quantity of the drive component at the current time. In some embodiments, the current control output quantity may be obtained by a measurement unit. The target control output quantity refers to a control output quantity that the drive component should achieve at the current time. In some embodiments, the target control output quantity may be determined based on target action (e.g., throttle control is equivalent to setting a target speed) of the user. The control output quantity error herein may also be understood as a deviation of an actual control output quantity from an expected control output quantity. More details regarding the control output quantity may be found in the related descriptions in the preceding sections.

In some embodiments, the processor may determine the control output quantity of the drive component at the next time under the braking condition, based on the control output quantity error of the drive component through a plurality of manners, such as a preset table or a machine learning model. More details regarding the preset table or the machine learning model may be found in the related descriptions in the preceding sections (e.g., FIG. 2 and FIG. 4).

When the drive component of the electric mobile device is in the operating mode of returning the braking energy to the power source, determining the control output quantity of the drive component at the next time under the braking condition based on the control output quantity error of the drive component may reduce the adverse effects of control inaccuracies caused by previous control output quantity error in subsequent control cycles, which improves the actual control experience of the user.

In practice, a prerequisite may also be set for the judgment of the operating mode to determine whether an actual rotation speed of the drive component is greater than a preset threshold (the threshold is generally set smaller). If the actual rotation speed is greater than the preset threshold, the judgment of the operating mode of the drive component is performed. If the actual rotation speed is less than or equal to the preset threshold, electromagnetic brakes hold, and it is determined that the control output quantity at the next time decays according to a set ratio based on the current control output quantity, and the control output quantity at the next time is set to zero when the control output quantity is less than a preset output.

When the drive component of the electric mobile device is not in the operating mode of returning the braking energy to the power source, a manner in which the control output quantity is updated varies based on a type of the drive component.

Motors are introduced as an example of the drive component. The motors are categorized into brushed motors and brushless motors. The brushed motors don't come with position sensors, which makes it impossible to get a motor speed directly. The brushless motors, on the other hand, use Hall sensors as position sensors.

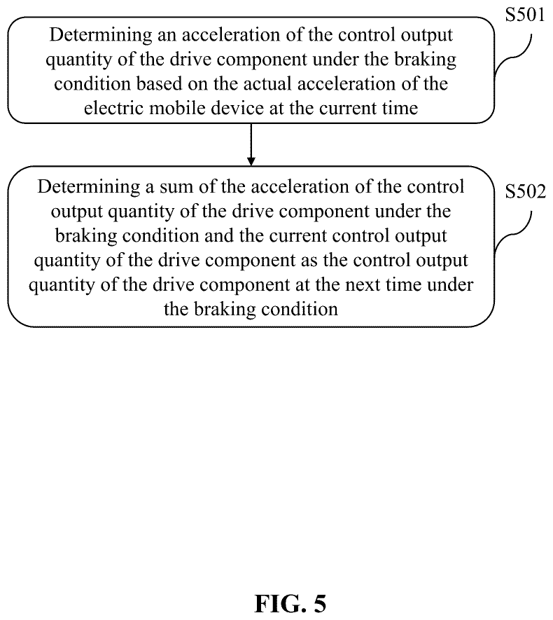

FIG. 5 is an exemplary flowchart illustrating a process for determining a control output quantity of a drive component at a next time under a braking condition based on a braking reference value according to some embodiments of the present disclosure.

For an electric mobile device using a brushed motor as the drive component, the braking reference value includes the actual acceleration of the electric mobile device at the current time. As illustrated in FIG. 5, determining the control output quantity of the drive component at the next time under the braking condition based on the braking reference value includes the following operations.

In S501, an acceleration of the control output quantity of the drive component under the braking condition may be determined based on the actual acceleration of the electric mobile device at the current time. The acceleration of the control output quantity may be understood as an increment or a correction value of the control output quantity within a unit time interval (i.e., the next time minus the current time). The acceleration of the control output quantity may be used to reflect how fast or slow the control output quantity changes within the unit time interval.

In S502, a sum of the acceleration of the control output quantity of the drive component under the braking condition and a current control output quantity of the drive component may be determined as the control output quantity of the drive component at the next time under the braking condition.

In some embodiments, the processor may perform a weighted summation on the acceleration of the control output quantity of the drive component under the braking condition and the current control output quantity of the drive component, to determine the control output quantity of the drive component at the next time under the braking condition. Weighting coefficients of the weighted summation may be set by a technician based on experience.

That is to say, without being in an operating mode of returning braking energy to a power source, there is no need to consider a control output quantity error, but rather just focus on the actual acceleration of the electric mobile device at the current time. Fine-tuning the control output quantity at the next time by the actual acceleration, combined with the effect of the actual acceleration, can reduce the experience of the user of a noticeable stutter at the end of the brakes on the electric mobile device.

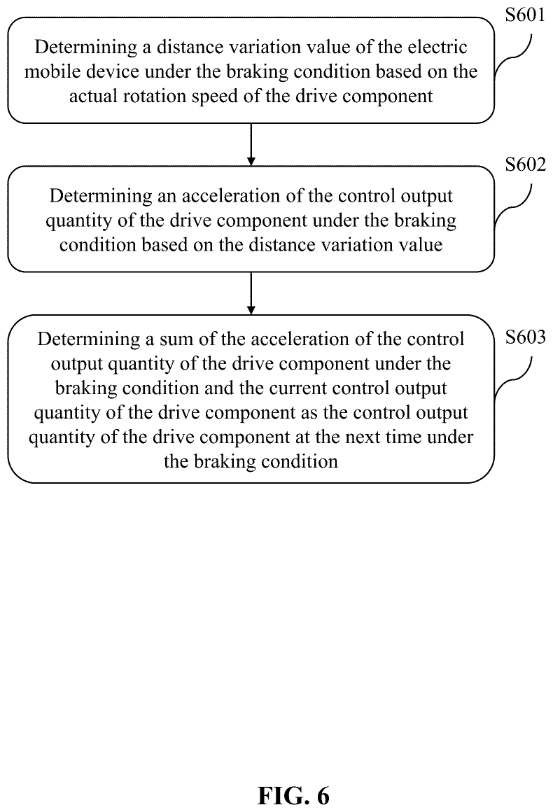

FIG. 6 is an exemplary flowchart illustrating a process for determining a control output quantity of a drive component at a next time under a braking condition based on a braking reference value according to some other embodiments of the present disclosure.

For an electric mobile device using a brushless motor as the drive component, as shown in FIG. 6, determining the control output quantity of the drive component at the next time under the braking condition based on the braking reference value, includes the following operations.

In S601, a distance variation value of the electric mobile device under the braking condition may be determined based on an actual rotation speed of the drive component. The distance variation value under the braking condition serves as the braking reference value.

More details regarding the actual rotation speed of the drive component may be found in FIG. 2 and the related descriptions.

The distance variation value refers to a theoretical driving distance of the electric mobile device from the start of braking until the speed reaches zero. In some embodiments, the processor may determined the distance variation value of the electric mobile device under the braking condition based on the actual rotation speed of the drive component.

In S602, an acceleration of a control output quantity of the drive component under the braking condition may be determined based on the distance variation value.

In some embodiments, the processor may determine the acceleration of the control output quantity of the drive component under the braking condition based on the distance variation value by querying a fourth preset table. The fourth preset table includes correspondence relationships between a plurality of sets of the distance variation values under the braking condition and the accelerations of the control output quantities of the drive component under the braking condition. In some embodiments, the fourth preset table may be constructed based on historical data.

In S603, a sum of the acceleration of the control output quantity of the drive component under the braking condition and a current control output quantity of the drive component may be determined as the control output quantity of the drive component at the next time under the braking condition.

By leveraging the characteristic of the brushless motor to obtain speed information and considering the distance variation value under the braking condition, it is possible to more accurately analyze whether the braking distance is long or short in a current braking condition. It may be understood that the acceleration of the control output quantity under the braking condition is negative, and the acceleration of the control output quantity determined by the distance variation value is able to reflect how fast or how slow the speed changes. Based on the acceleration and the current control output quantity, determining the control output quantity at the next time can achieve a smoother deceleration during braking, reducing the jerkiness at the end of the braking process.

Combined with FIG. 3, it may be seen that there exists a possible second suboperation condition for a coasting condition. When starting uphill, if a throttle toggle fluctuates very little, the electric mobile device may have a backward coasting phenomenon, and the larger the slope, the larger the backward coasting distance. When users encounter slopes while operating the electric mobile device, the backward coasting phenomenon during uphill starts gives the impression that the electric mobile device is out of control, negatively impacting the user experience and posing potential safety risks. If an operation condition estimation of the electric mobile device is a second operation condition, and specifically the coasting condition among a plurality of second suboperation conditions, the following describes a manner for determining the control output quantity of the drive component at the next time under the coasting condition based on reference data and a preset rule. The purpose of such a setting is to improve the driving experience under the coasting condition by timely updating the control output quantity at the next time under the coasting condition.

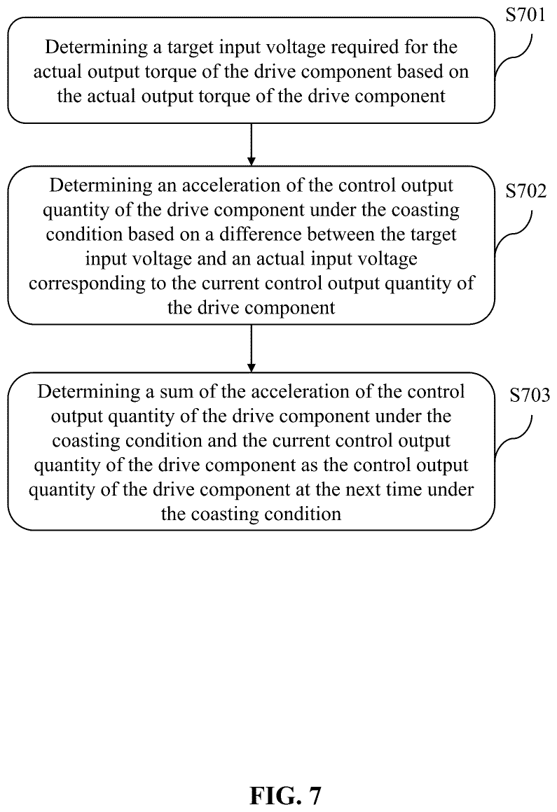

FIG. 7 is a flowchart illustrating an exemplary process for determining a control output quantity of a drive component at a next time under a coasting condition based on a coasting reference value and a preset rule according to some embodiments of the present disclosure.

For an electric mobile device using a brushed motor as the drive component, the reference data includes the coasting reference value, and the coasting reference value includes an actual output torque of the drive component. As shown in FIG. 7, determining the control output quantity of the drive component at the next time under the coasting condition based on the coasting reference value and the preset rule includes the following operations.

In S701, a target input voltage required for the actual output torque of the drive component may be determined based on the actual output torque of the drive component.

The target input voltage refers to a voltage required to realize the actual output torque of the drive component. In some embodiments, the processor may determine the target input voltage required for the actual output torque based on the actual output torque of the drive component according to formulas (1) and (2) as following:

$$T = {k}_{t} \cdot I \qquad ( 1 )$$

$$U = I \cdot R + {k}_{e} \cdot ω \qquad ( 2 )$$

wherein, T denotes the actual output torque; kₜ denotes a motor torque constant (unit N-m/A); R denotes an armature resistance; kₑ denotes a counterpotential constant (unit V/(rad/s)); ω denotes an actual angular speed; and U denotes the target input voltage. In some embodiments, kₜ, R, and kₑ are default settings of the electric mobile device, and ω may be obtained by a tachometer or encoder measurements.

In S702, an acceleration of a control output quantity of the drive component under the coasting condition may be determined based on a difference between the target input voltage and an actual input voltage corresponding to a current control output quantity of the drive component.

In some embodiments, the processor may determine to obtain the acceleration of the control output quantity of the drive component under the coasting condition based on the difference between the target input voltage and the actual input voltage corresponding to the current control output quantity of the drive component. An exemplary determination formula may include:

$$Δ u = {K}_{p} \cdot Δ V + {K}_{i} \cdot Σ Δ V ( i ) \cdot Δ t \qquad ( 3 )$$

$$Δ V = U - u \qquad ( 4 )$$

wherein, Δu denotes the acceleration of the control output quantity of the drive component under the coasting condition; Kₚ denotes a proportional gain; ΔV denotes the difference between the target input voltage and the actual input voltage corresponding to the current control output quantity of the drive component; Kᵢ denotes an integral gain; ΣΔV (i) denotes an integral term of errors; Δt denotes a control period or a sampling period; u denotes the actual input voltage corresponding to the current control output quantity. Kₚ and Kᵢ may be preset by a technician. u may be determined based on the current control output quantity of the drive component. For example, the actual input voltage may be equal to a product of a pulse width modulation (PWM) duty cycle and a bus voltage.

In S703, a sum of the acceleration of the control output quantity of the drive component under the coasting condition and the current control output quantity of the drive component may be determined as the control output quantity of the drive component at the next time under the coasting condition.

In the implementation, the impact of backward coasting is assessed by comparing the difference between the target input voltage of the drive component and the actual input voltage corresponding to the current control output quantity of the drive component, and the acceleration of the control output quantity under the coasting condition is determined accordingly. Through the manner, the impact of backward coasting can be compensated for in the setting of the control output quantity at the next time, thereby enhancing the control experience of the user of the electric mobile device during the coasting condition.

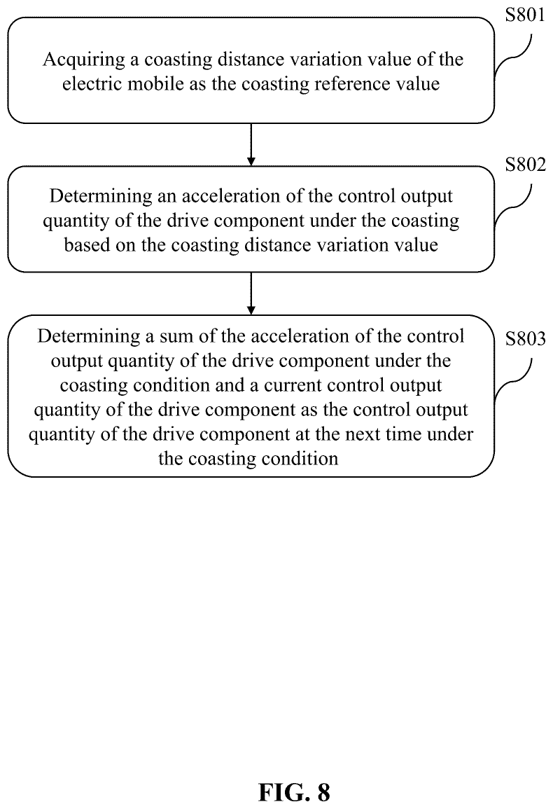

FIG. 8 is an exemplary flowchart illustrating a process for determining a control output quantity of a drive component at a next time under a coasting condition based on a coasting reference value and a preset rule, according to some other embodiments of the present disclosure.

For an electric mobile device using a brushless motor as the drive component. As shown in FIG. 8, determining the control output quantity of the drive component at the next time under the coasting condition based on the coasting reference value and the preset rule includes the following operations.

In S801, a coasting distance variation value of the electric mobile device may be acquired to as the coasting reference value.

The coasting distance variation value refers to a cumulative distance the electric mobile device has coasted backward on a slope or flat road from a time coasting began to the current time. In some embodiments, the processor may determine the coasting distance variation value of the electric mobile device based on the actual rotation speed of the drive component.

In S802, an acceleration of the control output quantity of the drive component under the coasting condition may be determined based on the coasting distance variation value.

In some embodiments, the processor may determine the acceleration of the control output quantity of the drive component under the coasting condition based on the coasting distance variation value by querying a fifth preset table. The fifth preset table may include corresponding relationships between a plurality of sets of the coasting distance variation values and the accelerations of the control output quantity of the drive component under the coasting condition. In some embodiments, the fifth preset table may be constructed based on historical data.

In S803, a sum of the acceleration of the control output quantity of the drive component under the coasting condition and a current control output quantity of the drive component may be determined as the control output quantity of the drive component at the next time under the coasting condition.

By leveraging the characteristic of the brushless motor to obtain speed information and considering the distance variation value under the coasting condition, it is possible to more accurately analyze whether the coasting distance is long or short in a current coasting condition. The acceleration of the control output quantity determined by the coasting distance variation value can reflect how fast or how slow the coasting speed changes. Based on the acceleration and the current control output quantity, the control output quantity at the next time can be determined, which, to some extent, compensates for the impact of backward coasting through the update of the control output quantity, thereby improving the issue of insufficient power during uphill driving.

Combined with FIG. 3, it may be seen that there exists a possible second suboperation condition of an overspeed condition. An overspeed problem is prone to occur on a downhill section. In the downhill section, a vehicle speed may exceed a set speed of a throttle toggle, giving a sense of downhill acceleration, affecting the user experience and posing a certain safety risk. If an operation condition estimation of the electric mobile device is a second operation condition, and specifically the overspeed condition among a plurality of second suboperation conditions, the following describes a manner for determining the control output quantity of the drive component at the next time under the overspeed condition based on reference data and the preset rule. The purpose of such a setting is to improve the driving experience under the overspeed condition by timely updating the control output quantity at the next time under the overspeed condition.

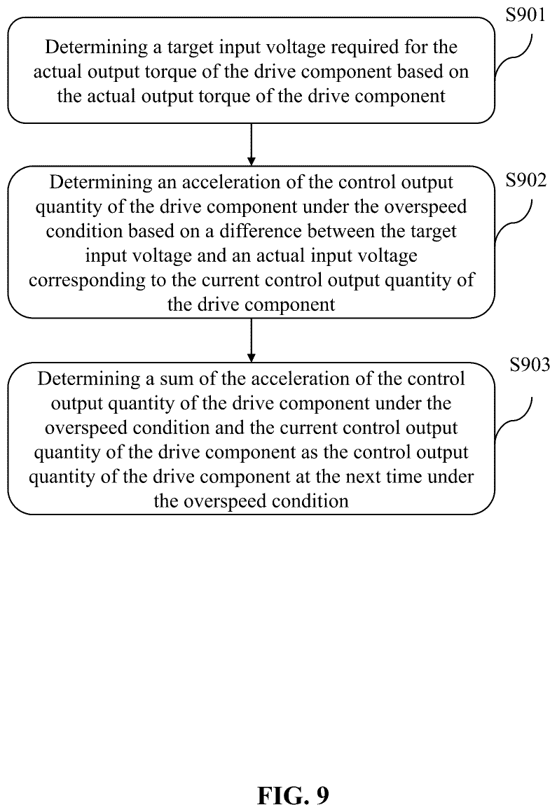

FIG. 9 is an exemplary flowchart illustrating a process for determining a control output quantity of a drive component at a next time under an overspeed condition based on an overspeed reference value and a preset rule, according to some embodiments of the present disclosure.

For an electric mobile device using a brushed motor as the drive component, reference data includes the overspeed reference value, and the overspeed reference value includes an actual output torque of the drive component. As shown in FIG. 9, determining the control output quantity of the drive component at the next time under the overspeed condition based on the overspeed reference value and the preset rule includes the following operations.

In S901, a target input voltage required for the actual output torque of the drive component may be determined based on the actual output torque of the drive component. More details regarding how to determine the target input voltage may be found in FIG. 7 and the related descriptions.

In S902, an acceleration of the control output quantity of the drive component under the overspeed condition may be determined based on a difference between the target input voltage and an actual input voltage corresponding to a current control output quantity of the drive component. It should be noted that the manner for determining the acceleration of the control output quantity of the drive component under the overspeed condition is similar to the manner for determining the acceleration of the control output quantity of the drive component under the coasting condition. More details may be found in FIG. 7 and the related descriptions, which may not be repeated here.

In S903, a sum of the acceleration of the control output quantity of the drive component under the overspeed condition and the current control output quantity of the drive component may be determined as the control output quantity of the drive component at the next time under the overspeed condition.

For the electric mobile device using the brushed motor as the drive component, the actual input voltage corresponding to the actual output torque of the drive component can be used to measure the deviation from the target input voltage, which is used to determine the acceleration and determine the control output quantity at the next time, thereby correcting the overspeed issue. By determining the deviation and updating the control output quantity in a timely manner, the experience of speeding can be improved, and the operation of the electric mobile device can be safer.

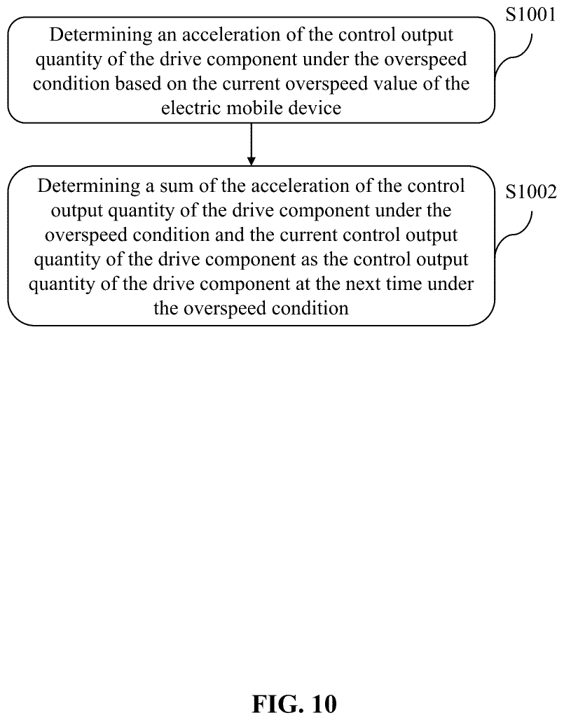

FIG. 10 is an exemplary flowchart illustrating a process for determining a control output quantity of a drive component at a next time under an overspeed condition based on an overspeed reference value and a preset rule, according to some other embodiments of the present disclosure.

For an electric mobile device using a brushless motor as the drive component, the overspeed reference value also includes a current overspeed value of the electric mobile device. As shown in FIG. 10, determining the control output quantity of the drive component at the next time under the overspeed condition based on the overspeed reference value and the preset rule includes the following operations.

In S1001, an acceleration of the control output quantity of the drive component under the overspeed condition may be determined based on the current overspeed value of the electric mobile device.

The current overspeed value refers to a value by which an actual speed of the electric mobile device exceeds a target speed at a current time. In some embodiments, the current overspeed value may be determined from the actual speed of the electric mobile device and the target speed of the electric mobile device. For example, the current overspeed value is equal to a difference between the actual speed and the target speed.

In some embodiments, the processor may determine to obtain the acceleration of the control output quantity of the drive component under the overspeed condition based on the current overspeed value of the electric mobile device. An exemplary determination formula may include:

$$Δ p = - {K}_{p} \cdot Δ v - {K}_{i} \cdot Σ Δ v ( i ) \cdot Δ t \qquad ( 5 )$$

wherein, Δp denotes the acceleration of the control output quantity of the drive component under the overspeed condition; Kₚ denotes a proportional gain; Δv denotes the current overspeed value; Kᵢ denotes an integral gain; ΣΔv(i) denotes an integral term of errors; and Δt denotes a control period or a sampling period. Kₚ Kᵢ may be preset by a technician, and Kₚ and Kᵢ in formula (5) may be or may not be the same as Kₚ and Kᵢ in formula (3).

In S1002, a sum of the acceleration of the control output quantity of the drive component under the overspeed condition and the current control output quantity of the drive component may be determined as the control output quantity of the drive component at the next time under the overspeed condition.

Combined with FIG. 3, it may be seen that there exists a possible second suboperation condition of a free deceleration condition. A control scheme is also provided in the embodiments of the present disclosure for the free deceleration condition. If an operation condition estimation of the electric mobile device is a second operation condition, and specifically the free deceleration condition among a plurality of second suboperation conditions, the following describes a manner for determining the control output quantity of the drive component at the next time under the free deceleration condition based on reference data and the preset rule. The purpose of such a setting is to adjust a change rule of the speed by timely updating the control output quantity at the next time under the free deceleration condition, thereby improving the driving experience under the free deceleration condition.

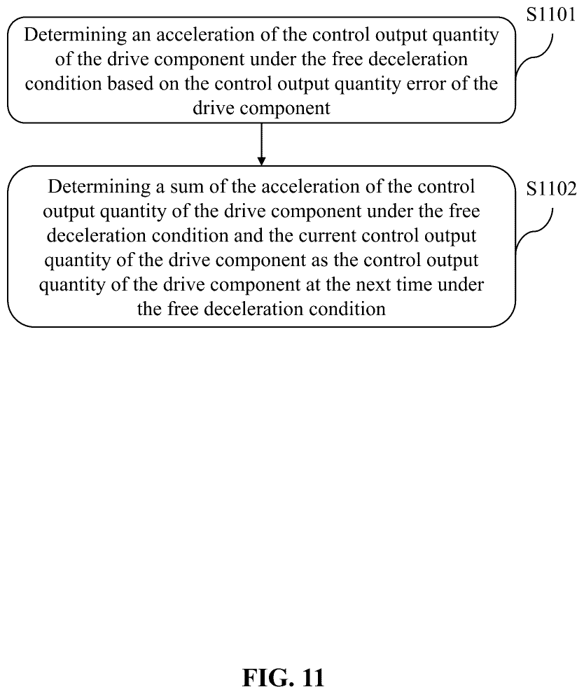

FIG. 11 is an exemplary flowchart illustrating a process for determining a control output quantity of a drive component at a next time under a free deceleration condition based on a free deceleration reference value and a preset rule according to some embodiments of the present disclosure.

For an electric mobile device using a brushed motor as the drive component, reference data includes the free deceleration reference value, and the free deceleration reference value includes a control output quantity error of the drive component. As shown in FIG. 11, determining the control output quantity of the drive component at the next time under the free deceleration condition based on the free deceleration reference value and the preset rule includes the following operations.

In S1101, an acceleration of the control output quantity of the drive component under the free deceleration condition based on a control output quantity error of the drive component.

More details regarding the control output quantity error of the drive component may be found in FIG. 4 and the related descriptions.

In some embodiments, the processor may determine the control output quantity of the drive component at the next time under the free deceleration condition, based on the control output quantity error of the drive component through a plurality of manners, such as a preset table or a machine learning model. More details regarding the preset table or the machine learning model may be found in the related descriptions in the previous sections (e.g., FIG. 2 and FIG. 4).

In some embodiments, the acceleration of the control output quantity of the drive component under the free deceleration conditions may be negatively correlated with the control output quantity error of the drive component. The greater the control output quantity error, the greater the acceleration (negative value) of the control output quantity.

In S1102, a sum of the acceleration of the control output quantity of the drive component under the free deceleration condition and the current control output quantity of the drive component as the control output quantity of the drive component at the next time under the free deceleration condition.

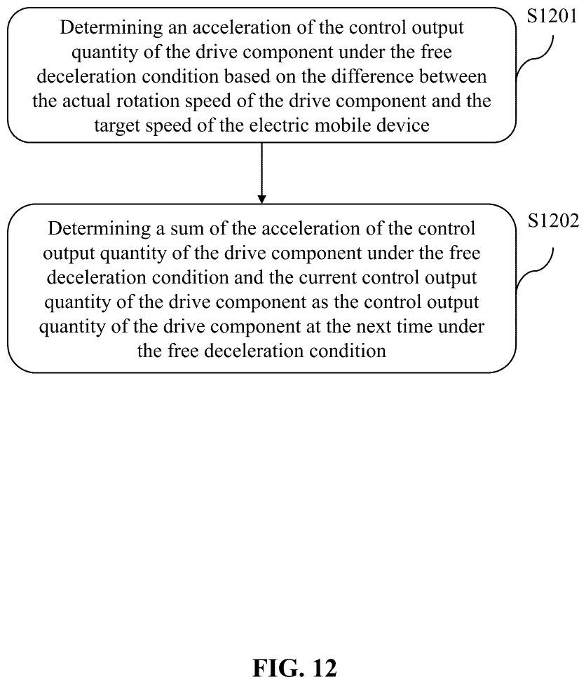

FIG. 12 is an exemplary flowchart illustrating a process for determining a control output quantity of a drive component at a next time under a free deceleration condition based on a free deceleration reference value and a preset rule, according to some other embodiments of the present disclosure.

For an electric mobile device using a brushless motor as the drive component, the free deceleration reference value also includes a difference between an actual rotation speed of the drive component and a target speed of the electric mobile device. As shown in FIG. 12, determining a control output quantity of the drive component at the next time under the free deceleration condition based on the free deceleration reference value and the preset rule includes the following steps.

In S1201, an acceleration of the control output quantity of the drive component under the free deceleration condition may be determined based on the difference between the actual rotation speed of the drive component and the target speed of the electric mobile device. The target speed may be obtained by conversion based on a value of a throttle toggle.

It should be noted that the difference between the actual rotation speed of the drive component and the target speed of the electric mobile device may be interpreted as a difference between an actual speed of the electric mobile device corresponding to the actual rotation speed of the drive component and the target speed of the electric mobile device. The actual rotation speed of the drive component may be converted to obtain the actual speed of the electric mobile device.

It is understandable that the manner for determining the acceleration of the control output quantity of the drive component under the free deceleration condition is similar to the manner for determining the acceleration of the control output quantity of the drive component under the overspeed condition. More details may be found in FIG. 10 and the related descriptions, which may not be repeated here.

In S1202, a sum of the acceleration of the control output quantity of the drive component under the free deceleration condition and the current control output quantity of the drive component may be determined as the control output quantity of the drive component at the next time under the free deceleration condition.

In some embodiments of the present disclosure, the acceleration is determined in combination with a deviation of the speed, and the control output quantity at the next time is set accordingly, so as to make the control of the speed in the free deceleration process more precise and the change of the speed more gentle, thereby improving the control experience of the user of the electric mobile device.

Combined with FIG. 3, it may be seen that there exists a possible second suboperation condition for a normal driving condition. The embodiments of the present disclosure also provide a control scheme for the normal driving condition. The control scheme does not distinguish whether the drive component is a brushed or brushless motor.

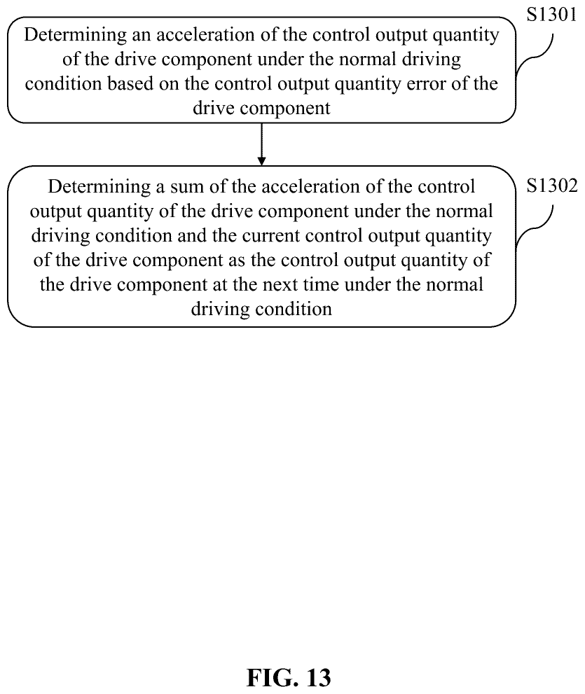

FIG. 13 is an exemplary flowchart illustrating a process for determining a control output quantity of a drive component at a next time under a normal driving condition based on a normal driving reference value and a preset rule, according to some embodiments of the present disclosure.

For the drive component exemplified by a motor, reference data includes the normal driving reference value, and the normal driving reference value includes a control output quantity error of the drive component. As shown in FIG. 13, determining the control output quantity of the drive component at the next time under the normal driving condition based on the normal driving reference value and the preset rule includes the following operations.

In S1301, an acceleration of the control output quantity of the drive component under the normal driving condition may be determined based on the control output quantity error of the drive component. More details regarding the control output quantity error may be found in FIG. 11 and the related descriptions.

In S1302, a sum of the acceleration of the control output quantity of the drive component under the normal driving condition and a current control output quantity of the drive component may be determined as the control output quantity of the drive component at the next time under the normal driving condition.

In the embodiment of the present disclosure, a manner for updating the control output quantity under the normal driving condition in FIG. 13 is similar to a manner of updating the control output quantity under a free deceleration condition in FIG. 11. However, it should be noted that there are some differences between the specific realization processes shown in FIG. 11 and FIG. 13. Specifically, fluctuations in speed changes of the electric mobile device during free deceleration and normal operation are not constant but exhibit characteristics corresponding to the operation condition. When determining the acceleration of the control output quantity based on the control output quantity error, different weights are configured for the acceleration, which assists in realizing the effect of a better fit to the needs of the operation condition under the corresponding operation condition.

In some embodiments, determining an operation condition estimation of the electric mobile device based on operational data includes the following process. First, it is determined whether the operation condition estimation of the electric mobile device is a first operation condition (e.g., whether it is a braking condition) based on the operational data. If the operation condition estimation of the electric mobile device is the first operation condition, the operation condition estimation that the electric mobile device is actually in is determined to be the first operation condition; and if the operation condition estimation of the electric mobile device is not the first operation condition, based on the operational data and a preset order, a second suboperation condition that the electric mobile device is actually in among a plurality of second suboperation conditions is determined. Since the second suboperation conditions have a plurality of types, including at least: the coasting condition, an overspeed condition, the free deceleration condition, and the normal driving condition. There are also several possible sequences for determining the second suboperation conditions described below.

Example determination sequence 1: determining the coasting condition, the overspeed condition, the free deceleration condition, and the normal driving condition in sequence.

Example determination sequence 2: determining the coasting condition, the free deceleration condition, the overspeed condition, and the normal driving condition in sequence.

Example determination sequence 3: determining the overspeed condition, the coasting condition, the free deceleration condition, and the normal driving condition in sequence.

Example determination sequence 4: determining the overspeed condition, the free deceleration condition, the coasting condition, and the normal driving condition in sequence.

Example determination sequence 5: determining the free deceleration condition, the overspeed condition, the coasting condition, and the normal driving condition in sequence.

Example determination sequence 6: determining the free deceleration condition, the coasting condition, the overspeed condition, and the normal driving condition in sequence.

If the operation condition estimation does not belong to any of the first operation condition, the coasting condition, the overspeed condition, or the free deceleration condition, it may be concluded that the operation condition estimation is the normal driving condition.

In some embodiments, determining that the operation condition estimation of the electric mobile device is the braking condition within the first operation condition based on the operational data includes determining whether a target speed is zero; if the target speed is zero, then determining the operation condition estimation of the electric mobile device as the braking condition. That is, when a user of the electric mobile device releases the throttle toggle, the target speed will be updated to 0 accordingly and the electric mobile device may be in the braking condition, while the actual speed of the driving component will gradually decrease to 0.

In some embodiments, determining that the operation condition estimation of the electric mobile device is the coasting condition based on the operational data includes the following two manners.

For the case in which the electric mobile device has a brushed motor as the drive component, the processor may determine a target input voltage required for an actual output torque of the drive component based on the actual output torque of the drive component; and in response to the target input voltage being greater than an actual input voltage of the drive component, determine that the operation condition estimation of the electric mobile device is the coasting condition. More details regarding the target input voltage and the actual input voltage may be found in the relevant descriptions in the previous sections (e.g., FIG. 2-FIG. 3).

For the case in which the electric mobile device has a brushless motor as the drive component, the processor may determine that the operation condition estimation of the electric mobile device is the coasting condition in response to the target speed of the drive component and an actual rotation speed of the drive component having different directions. More details regarding the target speed of the electric mobile device and the actual rotation speed of the drive component may be found in the related descriptions in the previous sections (e.g., FIG. 2).

It should be noted that the target speed of the drive component and the actual rotation speed of the drive component having different directions may be understood as a vector direction of the target speed of the electric mobile device being opposite to a vector direction of the actual rotational speed of the drive component. For example, if the electric mobile device is in a forward state, the vector direction of the target speed of the electric mobile device is considered positive, whereas if the electric mobile device is in a reverse state, the vector direction of the target speed of the electric mobile device is considered negative. Similarly, if the drive component is in a forward rotation state, the vector direction of the actual rotation speed of the drive component is considered positive, whereas if the drive component is in a reverse rotation state, the vector direction of the actual rotation speed of the drive component is considered negative.

In some embodiments, determining that the operation condition estimation of the electric mobile device is the overspeed condition based on the operational data includes the following two manners.

For the case in which the electric mobile device has the brushed motor as the drive component, the processor may determine that the operation condition estimation of the electric mobile device is the overspeed condition, in response to the actual output torque of the drive component and the actual rotation speed of the drive component having different directions. More details regarding the actual output torque of the drive component may be found in the relevant descriptions in the previous sections (e.g., FIG. 2).

Similarly, the actual output torque of the drive component and the actual rotation speed of the drive component having different directions may be understood as a vector direction of the actual output torque of the drive component being opposite to the vector direction of the actual rotation speed of the drive component. For example, if the actual output torque of the drive component is in a driving state (i.e., positive torque), the vector direction of the actual output torque is considered positive, whereas if the actual output torque of the drive component is in a braking or generating state (i.e., negative torque), the vector direction of the actual output torque is considered negative. More details regarding the vector direction of the actual rotation speed of the drive component may be found in the related descriptions in the preceding sections.

For the case in which the electric mobile device has the brushless motor as the drive component, the processor may determine that the operation condition estimation of the electric mobile device is the overspeed condition, in response to the target speed of the electric mobile device and the actual rotation speed of the drive component having a same direction. Similarly, the target speed of the electric mobile device and the actual rotation speed of the drive component having the same direction may be understood as the vector direction of the target speed of the electric mobile device being the same as the vector direction of the actual rotation speed of the drive component. More details regarding the vector directions may be found in the related descriptions in the preceding sections.

In some embodiments, determining that the operation condition estimation of the electric mobile device is the free deceleration condition based on the operational data includes the following two manners.

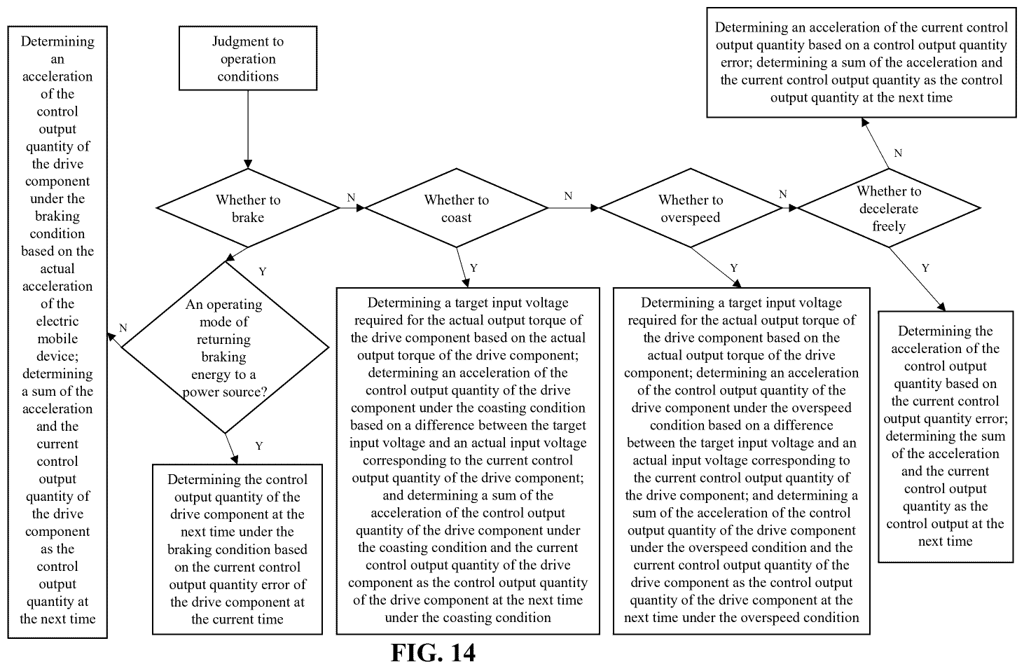

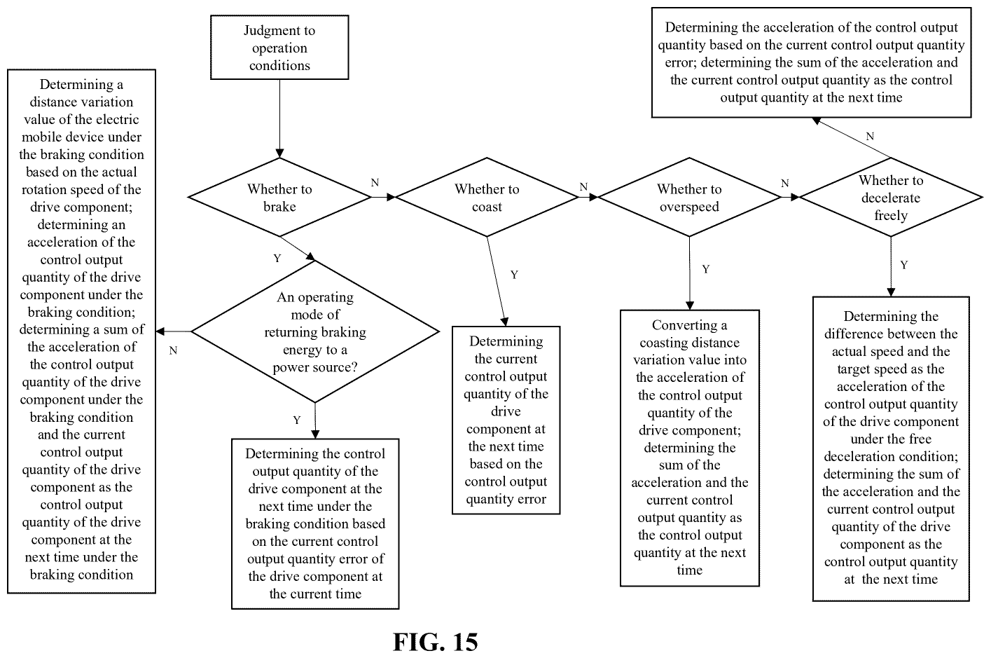

For the case in which the electric mobile device has the brushed motor as the drive component, the processor may determine that the operation condition estimation of the electric mobile device is the free deceleration condition, in response to the actual output torque of the drive component and the actual rotation speed of the drive component having a same direction. Similarly, the actual output torque of the drive component and the actual rotation speed of the drive component having the same direction may be understood as the vector direction of the actual output torque of the drive component being the same as the vector direction of the actual rotation speed of the drive component. More details regarding the vector directions may be found in the related descriptions in the preceding sections. For the case in which the electric mobile device has the brushless motor as the drive component, the processor may determine that the operation condition estimation of the electric mobile device is the free deceleration condition, in response to the target speed of the electric mobile device and the actual rotation speed of the drive component having a same direction. Similarly, the target speed of the electric mobile device and the actual rotation speed of the drive component having the same direction may be understood as the vector direction of the target speed of the electric mobile device being the same as the vector direction of the actual rotation speed of the drive component. More details regarding the vector directions may be found in the related descriptions in the preceding sections. FIG. 14 and FIG. 15 respectively illustrate implementation processes of two control methods for an electric mobile device. FIG. 14 is an implementation flowchart illustrating a control method of an electric mobile device having a brushed motor as a drive component according to some embodiments of the present disclosure; FIG. 15 is an implementation flowchart illustrating a control method of an electric mobile device having a brushless motor as a drive component according to some embodiments of the present disclosure.

In the previously described embodiments, by analyzing whether an operation condition estimation of the electric mobile device falls under a first operation condition or a second operation condition, and by applying a corresponding target control strategy, precise control can be achieved when the electric mobile device is in the first operation condition or in each suboperation condition of the second operation condition, which ensures safe driving under operation conditions such as braking, coasting, overspeed, free deceleration, and normal driving, while significantly enhancing the user experience. At the same time, such a setting can also improve the uneven experience of poor timeliness or too fast startup on flat roads, improve the problem of serious coasting with slope startup or weak uphill power, improve the experience of excessive downhill speed, and improve the experience of brake stuttering caused by the abrupt or weak end of the brake.

Currently, the electric mobile device on the market, such as a mobility tool, lacks sufficient intelligence when it comes to handling uphill and downhill slopes, and does not utilize a measurement unit for detecting an inclination angle of the mobility tool, or the inclination angle is detected based on a single threshold value. An actual driving surface is often diverse and complex, resulting in insufficient fault-tolerant performance of the mobility tool in a detection process, and misdetection may occur. The mobility tool places high demands on road conditions and are unable to identify hazardous situations accurately. As a result, elderly users may misjudge the slope of a hill or fail to notice it in time while navigating uphill or downhill, leading to incidents such as the mobility tool sliding uncontrollably, which seriously endangers the safety of elderly users and may even result in accidents involving the vehicle overturning or causing injury.

In some embodiments, the operational data of the electric mobile device further includes an inclination angle of the electric mobile device relative to a horizontal road surface. The operation condition estimation of the electric mobile device includes a third operation condition, and the third operation condition includes a first slope condition, a second slope condition, or a third slope condition.

In some embodiments, determining the operation condition estimation of the electric mobile device based on the operational data includes: determining the operation condition estimation of the electric mobile device by comparing the inclination angle to a plurality of angle thresholds in a preset angle threshold set. The preset angle thresholds set includes at least: a first angle threshold, a second angle threshold, and a third angle threshold. The first angle threshold is less than the second angle threshold and the second angle threshold is less than the third angle threshold. That is, there is a numerical difference in different angle thresholds of the preset angle threshold set as a measure of the steepness of the slope and the impact on the mobility performance of the electric mobile device.

Determining the operation condition estimation of the electric mobile device based on the relative magnitude of the inclination angle to the plurality of angle thresholds in the preset angle threshold set includes in response to the inclination angle being less than the first angle threshold, determining that the operation condition estimation of the electric mobile device is the first slope condition; in response to the inclination angle remaining greater than the second angle threshold and less than the third angle threshold for a first accumulated time exceeding a first time threshold, determining that the operation condition estimation of the electric mobile device is the second slope condition; in response to the inclination angle remaining greater than the third angle threshold for a second accumulated time exceeding a second time threshold, determining that the operation condition estimation of the electric mobile device is the third slope condition.

The first accumulated time refers to a duration for which the inclination angle is greater than the second angle threshold and less than the third angle threshold. The second accumulated time refers to a duration for which the inclination angle is greater than the third angle threshold. The first time threshold and the second time threshold may be the same or different, for example, set to a same time threshold t (i.e., a set time t).

Merely by way of example, the first angle threshold ranges from 1° to 5°, the second angle threshold ranges from 5° to 9°, and the third angle threshold ranges from 9° to 12°. In some embodiments, the first angle threshold is 5°, the second angle threshold is 9°, and the third angle threshold is 12°.

Determining a target control strategy corresponding to the operation condition estimation in different slope operation conditions, includes if the operation condition estimation is the first slope condition, determining the target control strategy including deactivating a voice broadcast device of the electric mobile device; if the operation condition estimation is the second slope condition, determining the target control strategy including controlling the voice broadcast device to issue a safety reminder; if the operation condition estimation is the third slope condition, determining the target control strategy including controlling the electric mobile device to decelerate.

A hazard level of the second slope condition is higher than a hazard level of the first slope condition, and a hazard level of the third slope condition is higher than the hazard level of the second slope condition. Different control strategies are adopted to control the electric mobile device for the slope conditions with different hazard levels, and to enhance the safety measures and safety tips of the electric mobile device.

In some embodiments, the inclination angle of the electric mobile device includes a forward inclination angle and a lateral inclination angle of the electric mobile device. The step for acquiring the forward inclination angle and the lateral inclination angle includes: acquiring acceleration information and angular velocity information of the electric mobile device; performing Kalman filter fusion on the acceleration information and the angular velocity information to determine a pitch angle and a roll angle of the electric mobile device; and setting the pitch angle as the forward inclination angle and the roll angle as the lateral inclination angle.

In embodiments of the present disclosure, by adding the plurality of angle thresholds and comparing the relative magnitude of the inclination angle and the plurality of angle thresholds, the actual operation condition of the electric mobile device on the slope can be more accurately determined, for example, the first slope condition, the second slope condition, or the third slope condition. By refining the operation condition estimations on the slope, it is possible to make the slope determination of the electric mobile device more stable and reliable. Under the premise, implementing control adapted to the actual operation conditions can prevent safety incidents such as tipping caused by improper control of the electric mobile device on slopes, thereby enhancing user experience and safety.

Currently, the electric mobile device on the market, such as the mobility tool, is prone to rollover at higher speeds, leading to safety accidents. And most of the existing electric mobility products do not have a turn deceleration function, or the mobility tool with a turn deceleration function, and most of the turn detection equipment used is a switch-type sensing device. During deceleration, the mobility device fails to identify and determine the current turning conditions, resulting in an inability to accurately obtain the corresponding turning information. Without precise determinations of the real-time turning conditions, the deceleration during turns becomes abrupt, delayed, or insufficient, which leads to poor anti-tipping effectiveness during deceleration and a subpar riding experience. In severe cases, it may cause the mobility device to tip over, posing significant safety risks and seriously endangering the safety of elderly users.

In some embodiments, the operational data of the electric mobile device also includes an actual linear speed and an actual angular speed of the electric mobile device. The operation condition estimation of the electric mobile device include a fourth operation condition, and the fourth operation condition includes a turning overspeed condition.

FIG. 16 is an exemplary flowchart illustrating a process for determining an operation condition estimation of an electric mobile device based on operational data according to some embodiments of the present disclosure. Determining the operation condition estimation of the electric mobile device based on the operational data, as shown in FIG. 16, includes the following operations.

In S1601, a turning radius of the electric mobile device may be determined based on an actual linear speed and an actual angular speed of the electric mobile device.

In some embodiments, the processor may determine to obtain the turning radius of the electric mobile device based on the actual linear speed and the actual angular speed of the electric mobile device. An exemplary determination formula may include:

$$v = wr \qquad ( 6 )$$

wherein, v denotes the actual linear speed; w denotes the actual angular speed; and r denotes the turning radius.

In S1602, a maximum linear speed of the electric mobile device may be determined based on the turning radius.

In S1603, in response to the actual linear speed being greater than the maximum linear speed, the operation condition estimation of the electric mobile device may be determined to be the turning overspeed condition.

In some embodiments, the processor may, in response to the operation condition estimation of the electric mobile device being the turning overspeed condition, determine the target control strategy including controlling the electric mobile device to reduce the actual linear speed to below the maximum linear speed.

In some embodiments, determining the maximum linear speed of the electric mobile device based on the turning radius includes: determining the maximum linear speed of the electric mobile device based on a preset centrifugal acceleration and the turning radius.

In some embodiments, determining the actual linear speed includes: determining the actual linear speed of the electric mobile device based on acceleration information of the electric mobile device, the actual angular speed of the electric mobile device, a rotation speed of a drive component of the electric mobile device, a reduction ratio, and a wheel diameter parameter of the electric mobile device.

If the actual linear speed of the electric mobile device is less than the maximum linear speed under the current turning condition, it indicates that the electric mobile device is operating at a safe turning speed, eliminating the risk of tipping over. If the actual linear speed of the electric mobile device is already greater than the maximum linear speed under the current turning condition, it indicates that the electric mobile device is in the risk of tipping under the current turning condition. In such cases, it is crucial to promptly reduce the speed to below the maximum linear speed of a mobility tool for the current turning condition, to ensure safe operation of the electric mobile device under the turning condition. The embodiments of the present disclosure enable the electric mobile device to decelerate more linearly and smoothly during turns, enhancing the driving experience by making it more seamless, which significantly reduces the risk of tipping during turns and improves overall user safety.

As mentioned earlier, in some embodiments, the electric mobile device may include the mobility tool such as an electric skateboard, a balance car, an electric wheelchair, a mobility scooter, or the like. The following is a detailed description of the specific implementation of the present disclosure in combination with specific embodiments using the mobility tool as an exemplary subject of description.

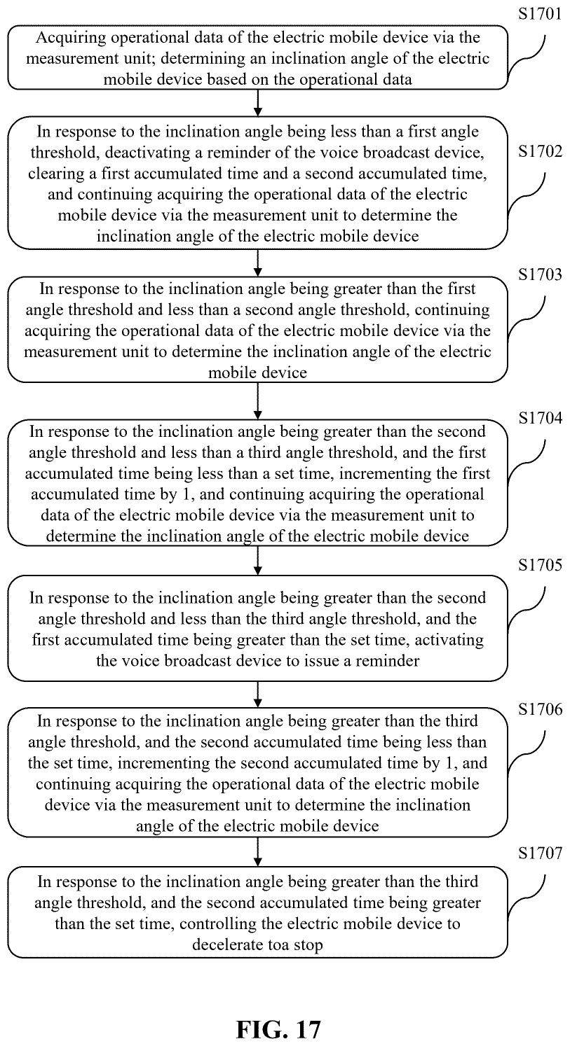

FIG. 17 is an implementation flowchart illustrating a process for slope safety reminder of an electric mobile device according to some embodiments of the present disclosure. For illustration, only portions related to the embodiments of the present disclosure are shown, as described in detail below.

In S1701, operational data of the electric mobile device may be acquired via a measurement unit; and an inclination angle of the electric mobile device (e.g., a mobility tool) may be determined based on the operational data.

Some embodiments of the present disclosure apply to an intelligent mobility tool system or platform. The mobility tool includes an elderly mobility scooter or a motorized wheelchair, etc., and the mobility tool system or platform includes the measurement unit, a voice broadcast device, and a processor, and the measurement unit includes an inertial measurement unit (IMU), etc.

The measurement unit includes an accelerometer and a gyroscope. The accelerometer measures accelerations of the mobility tool along three axes (i.e., an X-axis, a Y-axis, and a Z-axis), while the gyroscope measures angular velocities of the mobility tool along three axes (i.e., the X-axis, the Y-axis, and the Z-axis).

The measurement unit acquires inspection data of the mobility tool (which may be referred to as the operational data of the electric mobile device), and the six-axis inspection data is fused by Kalman filter fusion. The detection data includes the acceleration and THE angular velocity of the mobility tool in the X axis, the acceleration and THE angular velocity of the mobility tool in the Y axis, and the acceleration and the angular velocity of the mobility tool in the Z axis. The Kalman filter fusion refers to an algorithm for optimally estimating a state of a system using a linear system state equation with system input and output observations.

A pitch angle and a roll angle of the mobility tool are obtained by the Kalman filter fusion. The pitch angle corresponds to a forward inclination angle al of the mobility tool, the roll angle corresponds to a lateral inclination angle a2 of the mobility tool, and the inclination angle a of the mobility tool includes the forward inclination angle al and the lateral inclination angle a2.

In S1702, in response to the inclination angle being less than a first angle threshold, a reminder of the voice broadcast device may be deactivated, a first accumulated time and a second accumulated time may be cleared, and the operational data of the electric mobile device may be continued acquiring via the measurement unit to determine the inclination angle of the electric mobile device. That is, the inclination angle may be compared with the angle thresholds θ1, θ2, θ3 (i.e., the first angle threshold θ1, a second angle threshold θ2, and a third angle threshold θ3), and if the inclination angle a is less than the angle threshold θ1, the reminder of the voice broadcast device is deactivated, and at the same time, time counting variables t1 and t2 (which may be referred to as the first accumulated time t1 and the second accumulated time t2) are cleared, and the operation S1701 is performed.

It should be noted that the inclination angle being compared with the angle thresholds θ1, θ2, θ3 refers to determining the magnitude of either the forward inclination angle a1 or the lateral inclination angle a2 relative to the set angle thresholds θ1, θ2, and θ3. For example, the inclination angle a being less than the set angle threshold θ1 means that either the forward inclination angle a1 or the lateral inclination angle a2 is less than the set angle threshold θ1.

In S1703, in response to the inclination angle being greater than the first angle threshold and less than a second angle threshold, the operational data of the electric mobile device may be continued acquiring via the measurement unit to determine the inclination angle of the electric mobile device. That is, if the inclination angle a is greater than θ1 and less than θ2, then the operation S1701 may be continued.

In S1704, in response to the inclination angle being greater than the second angle threshold and less than a third angle threshold, and the first accumulated time being less than a set time, the first accumulated time may be incremented by 1, and the operational data of the electric mobile device may be continued acquiring via the measurement unit to determine the inclination angle of the electric mobile device. That is, if the inclination angle a is greater than θ2 and less than θ3, whether the time counting variable t1 is greater than the set time tis determined, if the time counting variable t1 is less than the set time t, the time counting variable t1 is added to 1, and the operation S1701 may be performed.

In S1705, in response to the inclination angle being greater than the second angle threshold and less than the third angle threshold, and the first accumulated time being greater than the set time, the voice broadcast device may be activated to issue a reminder. That is, if the inclination angle a is greater than θ2 and less than θ3, whether the time counting variable t1is greater than the set time t is determined, and if the time counting variable t1 is greater than the set time t, the voice broadcast device issues a reminder.

In some embodiments of the present disclosure, the angle thresholds θ1, θ2, and θ3 are set to be three different thresholds for measuring the slope. Here the angle thresholds θ1, θ2, and θ3 may be the first angle threshold, the second angle threshold, and the third angle threshold, respectively, as described in the embodiment above. The first angle threshold is the smallest and the third angle threshold is the largest. The set angle threshold θ1 ranges from 1° to 5°, the set angle threshold θ2 ranges from 5° to 9°, and the set angle threshold θ3 ranges from 9° to 12°.

In some embodiments, the set angle threshold θ1 is 3°, the set angle threshold θ2 is 6°, and the set angle threshold θ3 is 10°. When a slope gradient is 3°, the slope is relatively flat, and at this time, the voice broadcast device may turn off the voice broadcast. When the slope gradient is 6°, the slope has a certain degree of inclination but remains within a relatively safe range, at which point, the voice broadcast device may be activated to remind the user to pay attention to driving safety on the current slope and avoid incidents such as vehicle coasting. If the measurement unit of the mobility tool detects that the inclination angle a of the mobility tool exceeds the angle threshold θ2, the time counting variable t1 is activated and begins cumulative timing. When the time counting variable t1 is less than the set time t, the time counting variable t1 is controlled to increment by 1; when the time counting variable t1 exceeds the set time t, the voice broadcast device is activated to alert the user that the slope has reached a dangerous gradient for a certain duration, prompting the user to slow down, brake, and pay attention to the surrounding environment, and additionally, the time counting variable t2 is cleared. When the slope gradient is 10°, the slope has a significant degree of inclination, and the mobility tool is prone to tipping accidents on the slope. Therefore, it is necessary to monitor the time counting variable t2 of the mobility tool when the inclination angle a of the mobility tool exceeds the set angle threshold θ3. When the time counting variable t2 does not exceed the set time t, the time counting variable t2 is controlled to increment by 1, continuing cumulative timing; when the time counting variable t2 exceeds the set time t, the mobility tool has been on a slope exceeding 10° for a prolonged period, posing a significant safety risk. In this case, the mobility tool is controlled to decelerate and stop to ensure the safety of the user.

In some embodiments, the set angle threshold θ1 is 5°, the set angle threshold θ2 is 9°, and the set angle threshold θ3 is 12°.

In some embodiments of the present disclosure, the time counting variable t1 is a counting of the accumulated time when the inclination angle a of the mobility tool is greater than the set angle threshold θ2 and less than the set angle threshold θ3. When the accumulated time is less than the set time t, the time counting variable t1 is controlled to increment by 1, the operation S1701 is returned to continue to command the measurement unit to detect the inclination angle a of the mobility tool and accumulate the time counting variable t1. When the accumulated time t1 is greater than the set time t, the voice broadcast device is triggered to activate, reminding the user that the current slope has reached a dangerous gradient for a certain duration. The user is advised to slow down, brake, and pay attention to the surrounding environment. Additionally, the time count variable t2 is cleared.

In some embodiments, the set time is one second.

In S1706, in response to the inclination angle being greater than the third angle threshold, and the second accumulated time being less than the set time, the second accumulated time may be incremented by 1, and the operational data of the electric mobile device may be continued acquiring via the measurement unit to determine the inclination angle of the electric mobile device. That is, if the inclination angle a is greater than θ3, whether the time counting variable t2 is greater than the set time t is determined, and when the time counting variable t2 is less than the set time t, the time counting variable t2 is added to 1, and the operation S1701 is performed.

In S1707, in response to the inclination angle being greater than the third angle threshold, and the second accumulated time being greater than the set time, the electric mobile device may be controlled to decelerate to a stop. That is, if the inclination angle a is greater than θ3, whether the time counting variable t2 is greater than the set time t is determined, and when the time counting variable t2 is greater than the set time t, the mobility tool is controlled to decelerate to a stop.

In some embodiments of the present disclosure, the time counting variable t2 is an accumulated time for counting the time when the inclination angle a of the mobility tool is greater than the set angular threshold θ3, and when the accumulated time is less than the set time t, the time counting variable t2 is controlled to increment by 1, and the process returns to the operation S1701, continue to command the measurement unit to detect the inclination angle a of the mobility tool and accumulate the time counting variable t2. When the accumulated time exceeds the set time t, the mobility tool has been on a slope exceeding the set angle threshold θ3 for a certain duration, posing a significant safety hazard. Therefore, the control slows down and stops the mobility tool to ensure the safety of the user.

In some embodiments, the set time is one second.

Some embodiments of the present disclosure also provide a control device for slope safety reminder of the electric mobile device, which includes the measurement unit, the voice broadcast device, and the processor, and the measurement unit and the voice broadcast device are electrically connected to the processor. In some embodiments, the processor is configured to perform a slope safety reminder method of the electric mobile device, such as operations S1701 to S1707 as shown in FIG. 17.

Some embodiments of the present disclosure also provide a non-transitory computer-readable storage medium storing computer programs, the computer programs being executed by the processor to implement the operations of the above embodiments, such as operations S1701 to S1707 as shown in FIG. 17.

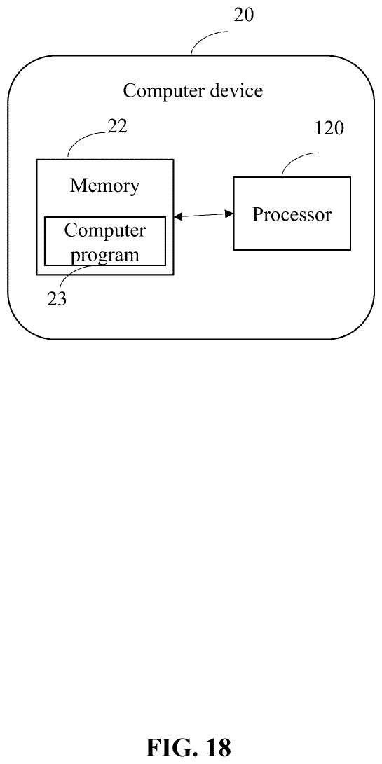

FIG. 18 is a schematic diagram illustrating a computer device according to some embodiments of the present disclosure, and for ease of illustration, only portions related to the embodiments of the present disclosure are shown, as described in detail below.

A computer device 20 of an embodiment of the present disclosure includes A processor 120, a memory 22, and a computer program 23 stored in the memory 22 and implemented on the processor 120. The processor 120 may perform the operations in the above embodiment when it executes the computer program 23, such as operations S1701 to S1707 as shown in FIG. 17.

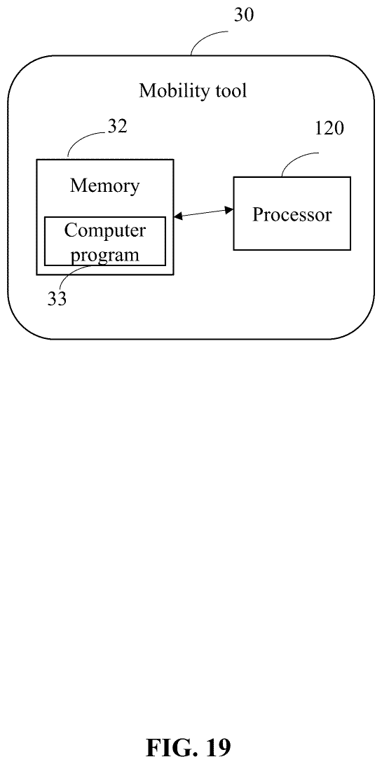

FIG. 19 is a block diagram illustrating an electric mobile device according to some embodiments of the present disclosure.

The electric mobile device may include a mobility tool 30. As shown in FIG. 19, the mobility tool 30 includes one or more processors 120, and a memory 32, the memory 32 storing a computer program 33, the computer program 33 being executed by the processor 120 to implement the operations in the above embodiment, such as, operations S1701 to S1707 as shown in FIG. 17.

With the aforementioned slope safety reminder method of the mobility tool, the mobility tool uses the measurement unit to perform Kalman filter fusion on the data of the measurement unit to obtain the forward inclination angle al and the lateral inclination angle a2 of the mobility tool; sets three different set angle thresholds θ1, θ2, and θ3, and by judging the relative magnitude between the inclination angle a of the mobility tool and the three different set angle thresholds θ1, θ2, and θ3, increases the judgment between the time counting variables t1, t2, and the set time t; and according to the relationship between the magnitude of the time counting variables t1, t2, and the set time t, turns on or off the reminder of the voice broadcast device, or performing automatic deceleration and stop. Such a setting significantly enhances the fault tolerance of slope detection for the mobility tool, ensuring more stable and reliable slope judgment, which prevents the mobility tool from tipping over, thereby improving the safety of the driving safety of the user.

The following describes in detail the specific implementation of the present disclosure in combination with specific embodiments.

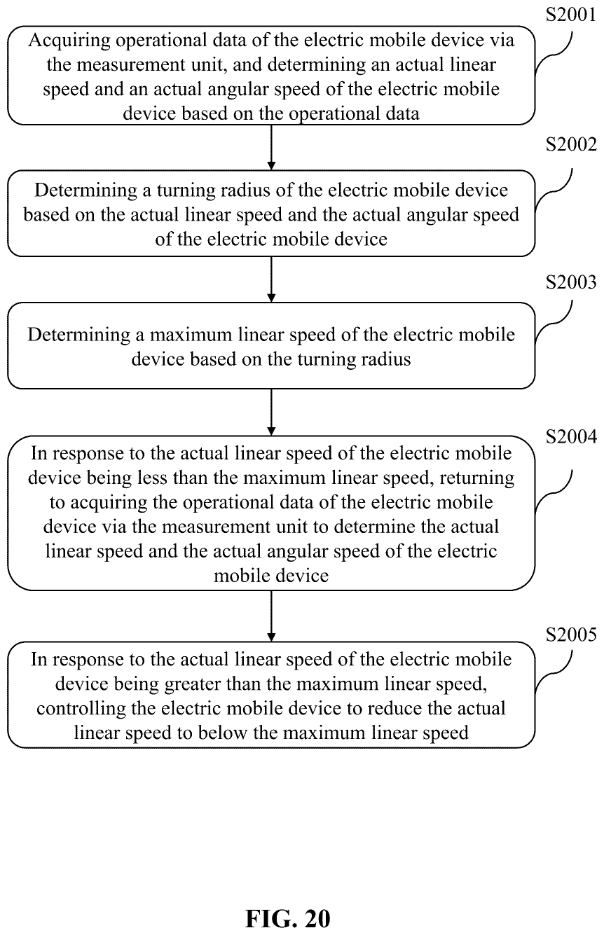

FIG. 20 is a flowchart illustrating an exemplary process for intelligent turning deceleration of an electric mobile device according to some embodiments of the present disclosure. For ease of illustration, only the portions related to the embodiments of the present disclosure are shown, as detailed below.

In S2001, operational data of the electric mobile device may be acquired via a measurement unit, and an actual linear speed and an actual angular speed of the electric mobile device may be determined based on the operational data. That is, the operational data of the electric mobile device (e.g., a mobility tool) is obtained by the measurement unit, and a linear speed v1 (i.e., the actual linear speed) and an angular speed w (i.e., the actual angular speed) of the mobility tool are determined based on the operational data.

In some embodiments, detection data of the mobility tool (which may be referred to as the operational data of the electric mobile device) obtained through the measurement unit includes an acceleration and an angular speed of the mobility tool along an X-axis, an acceleration and an angular speed along a Y-axis, and an acceleration and an angular speed along a Z-axis. The six-axis detection data is then performed Kalman filter fusion. A pitch angle and a roll angle of the mobility tool may be obtained by Kalman filter fusion, and the angular speed of the mobility tool in the Z-axis corresponds to the angular speed w of the rotation of the mobility tool. More details regarding how the measurement unit acquires the operational data of the electric mobile device may be found in the previous section (e.g., FIG. 17) in the related descriptions.

In some embodiments, the processor may determine the linear speed v1 of the mobility tool based on acceleration of the mobility tool, the angular speed w of the mobility tool, a rotational speed of a drive component, a reduction ratio, and a wheel diameter parameter of the mobility tool.

In S2002, a turning radius of the electric mobile device may be determined based on the actual linear speed and the actual angular speed of the electric mobile device. That is, based on the linear speed v1 and the angular speed w of the mobility tool, the turning radius r of the mobility tool is determined.

In some embodiments, the processor may obtain the turning radius r of the mobility tool at the point based on the linear speed v1 and the angular speed w of the mobility tool by a formula (6) described above.

In S2003, a maximum linear speed of the electric mobile device may be determined based on the turning radius. That is, based on the turning radius r of the mobility tool, the maximum linear speed v2 of the mobility tool is determined under a current operation condition.

In some embodiments, the processor may determine the maximum linear speed v2 of the mobility tool under the current operation condition by using a preset centrifugal acceleration a and the turning radius. An exemplary determination formula may include:

$$v 2 = \sqrt{( a \cdot r )} \qquad ( 7 )$$

wherein, v2 denotes the maximum linear speed of the mobility tool under the current operation condition; a denotes the preset centrifugal acceleration; and r denotes the turning radius of the mobility tool.

In S2004, in response to the actual linear speed of the electric mobile device being less than the maximum linear speed, the operational data of the electric mobile device may be continued to be acquired via the measurement unit to determine the actual linear speed and the actual angular speed of the electric mobile device. That is, a relationship between the maximum linear speed v2 of the mobility tool under the current operation condition and the linear speed v1 is determined, and if the linear speed v1 is less than the maximum linear speed v2 under the current operation condition, the process returns to execute operation S2001.

In some embodiments, based on the determined linear speed v1 of the mobility tool in a current turning environment and the critical maximum linear speed v2 that the mobility tool may achieve in the same environment, the relationship between v1 and v2 is used to determine whether the mobility tool should decelerate or maintain its current turning linear speed v1. If the actual turning linear speed v1 of the mobility tool is less than the maximum linear speed v2 under the current turning condition, it indicates that the mobility tool is operating at a safe turning speed without the risk of tipping over. Therefore, there is no need to reduce the current linear speed v1 of the mobility tool, and the process continues to execute operation S2001 to detect the real-time linear speed v1 of the mobility tool in the current turning condition.

In S2005, in response to the actual linear speed of the electric mobile device being greater than the maximum linear speed, the electric mobile device may be controlled to reduce the actual linear speed to below the maximum linear speed. That is, the relationship between the maximum linear speed v2 of the mobility tool under the current operation condition and the current linear speed v1 is determined, and if the current linear speed v1 exceeds the maximum linear speed v2 under the current operation condition, the mobility tool is controlled to decelerate until the speed is reduced to below the maximum linear speed v2.

In some embodiments, if the actual turning linear speed v1 of the mobility tool exceeds the maximum linear speed v2 under the current turning condition, it indicates that the mobility tool is at risk of tipping over in the current turning environment. Therefore, it is necessary to promptly control the mobility tool to decelerate to the maximum linear speed v2 or below under the current turning condition, ensuring the safety of the mobility tool during the turn.

Some embodiments of the present disclosure also provide a control device for intelligent turning deceleration of the electric mobile device, the device including a measurement unit and a processor, the measurement unit being electrically connected to the processor. In some embodiments, the processor is configured to perform a method for intelligent turning deceleration of the electric mobile device, such as operations S2001 to S2005 as shown in FIG. 20.

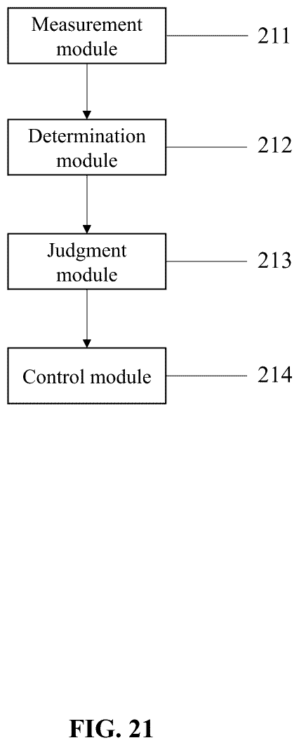

FIG. 21 is a schematic diagram illustrating an exemplary control system for intelligent turning deceleration of an electric mobile device according to some embodiments of the present disclosure.

Some embodiments of the present disclosure provide the control system for intelligent turning deceleration of the electric mobile device. The electric mobile device includes a mobility tool such as an elderly mobility scooter or a motorized wheelchair. As shown in FIG. 21, the control system for intelligent turning deceleration of the electric mobile device includes the following modules: a measurement module 211, a determination module 212, a judgment module 213, and a control module 214.

The measurement module 211 is configured to collect acceleration information and angular velocity information of the mobility tool, and determine to obtain a linear speed v1 and an angular speed w of the mobility tool based on the acceleration information and the angular velocity information of the mobility tool.

In the measurement module 211, the acceleration information of the mobility tool and the angular speed w of the mobility tool are determined to obtain the linear speed v1 of the mobility tool by combining a motor speed of the mobility tool with a reduction ratio and a wheel diameter parameter of the mobility tool.

As a preferred embodiment, the measurement module 211 includes an IMU.

The determination module 212 is configured to determine a turning radius r of the mobility tool based on the linear speed v1 and the angular speed w of the mobility tool, and to calculate a maximum linear speed v2 of the mobility tool in a current operation condition based on the turning radius r of the mobility tool.

The determination module 212 further includes a preset centrifugal acceleration a, and determines the maximum linear speed v2 of the mobility tool under the current operation condition by the preset centrifugal acceleration a and the turning radius.

The judgment module 213 is configured to determine a magnitude relationship between the maximum linear speed v2 of the mobility tool under the current operation condition and the linear speed v1 of the mobility tool, and when the linear speed v1 of the mobility tool is less than the maximum linear speed v1 of the mobility tool under the current operation condition, then return to the measurement module to continue the measurement.

If the judgment module 213 determines that the actual turning linear speed v1 of the mobility tool is less than the maximum linear speed v2 under a current turning condition, it indicates that the mobility tool is operating at a safe turning speed and is not at risk of tipping over. Therefore, there is no need to reduce the current linear speed v1 of the mobility tool. The process returns to the measurement module to continue monitoring the real-time linear speed v1 of the mobility tool under the current turning condition.

The control module 214 is configured to control the deceleration of the mobility tool to below the maximum linear speed v2 of the mobility tool under the current operation condition when the linear speed v1 of the mobility tool is greater than the maximum linear speed v2 of the mobility tool under the current operation condition.

In the control module 214, if the actual turning linear speed v1 of the mobility tool exceeds the maximum linear speed v2 under the current turning condition, it indicates that the mobility tool is at risk of tipping over in the current turning environment. Therefore, it is necessary to promptly reduce the speed of the mobility tool to the maximum linear speed v2 or below, ensuring the safety of the mobility tool under the current turning condition.

Some embodiments of the present disclosure also provide a non-transitory computer-readable storage medium storing computer programs, the computer programs being executed by a processor to realize the operations in the above embodiments, such as, operations S2001 to S2005 as shown in FIG. 20; and/or, the computer programs when executed by the processor realize the functions of the modules of the control device for intelligent turning deceleration of the electric mobile device in the embodiment, such as, the functions of the modules 211 to 214 as shown in FIG. 21; and/or, the computer programs when executed by the processor realize the operations of the control method for the electric mobile device in the above embodiment.

The computer program 23 when executed by the processor 120 of the computer device illustrated in FIG. 18 also realizes the operations of the above embodiment, such as operations S2001 to S2005 illustrated in FIG. 20; and/or, the computer program 23 when executed by the processor 120 realizes the functions of the modules of the control device for intelligent turning deceleration of the electric mobile device in the embodiment, such as the functions of the modules 211 to 214 illustrated in FIG. 21; and/or, the computer program 23 when executed by the processor 120 may also realize the operations of the control method for the electric mobile device in the above embodiment.

The computer program 33 in the mobility tool 30 illustrated in FIG. 19 when executed by the processor 120 realizes the operations of the above embodiment, such as, operations S2001 to S2005 illustrated in FIG. 20; and/or, the computer program 33 when executed by processor 120 realizes the functions of the modules of the control device for intelligent turning deceleration of the electric mobile device in the embodiment, such as, the functions of the modules 211 to 214 illustrated in FIG. 21; and/or, the computer program 33 when executed by processor 120 realizes the operations of the control method for the electric mobile device in the above embodiment.

Through the control method for intelligent turning deceleration of the electric mobile device described above, the processor of the electric mobile device (such as the mobility tool) uses the measurement unit to measure the real-time posture of the mobility tool, thereby obtaining the overall linear speed and angular speed of the mobility tool during the turn. Based on the overall linear speed and angular speed during the turn, the turning radius of the current turning environment is determined. Using the preset centrifugal acceleration and the determined turning radius, the maximum linear speed of the mobility tool under the current turning condition is iteratively determined in real time. The maximum linear speed is then compared with the actual turning linear speed of the mobility tool. If the actual turning linear speed of the mobility tool is less than the maximum linear speed under the current turning condition, it indicates that the mobility tool is operating at the safe turning speed and there is no risk of tipping over. If the actual turning linear speed exceeds the maximum linear speed, it suggests that the mobility tool is at risk of tipping over under the current turning condition. In such cases, the mobility tool can promptly decelerate to the maximum linear speed or below to ensure safe turning. By continuously updating and comparing the actual linear speed with the theoretical maximum turning linear speed in real time, the turning linear speed of the mobility tool is effectively controlled. The approach ensures that the mobility tool decelerates more linearly and smoothly during the turn, enhancing the driving experience and significantly reducing the risk of tipping over. As a result, the safety of the user is greatly improved.

The basic concepts have been described above, and it is apparent to a person skilled in the art that the above detailed disclosure serves only as an example and does not constitute a limitation of the present disclosure. While not expressly stated herein, a person skilled in the art may make various modifications, improvements, and amendments to the present disclosure.

Those types of modifications, improvements, and amendments are suggested in the present disclosure, so those types of modifications, improvements, and amendments remain within the spirit and scope of the exemplary embodiments of the present disclosure.

What is claimed is:

1. A control device for an electric mobile device, comprising: a measurement unit and a processor, wherein the measurement unit is electrically connected to the processor; and the processor is configured to:
acquire operational data of the electric mobile device via the measurement unit;
determine an operation condition estimation of the electric mobile device based on the operational data;
determine a target control strategy corresponding to the operation condition estimation;
generate a control instruction based on the target control strategy; and
control the electric mobile device to perform a corresponding operation according to the target control strategy.

2. The control device according to claim 1, wherein the processor is further configured to:
in response to the operation condition estimation being a first operation condition, determine the target control strategy including: determining a control output quantity of a drive component of the electric mobile device at a next time under the first operation condition based on an operating mode of the drive component at a current time; and
in response to the operation condition estimation being a second operation condition, determine the target control strategy including: acquiring reference data corresponding to the second operation condition; and determining the control output quantity of the drive component at the next time under the second operation condition based on the reference data and a preset rule.

3. The control device according to claim 2, wherein the operational data includes a target speed of the electric mobile device; the first operation condition includes a braking condition; and
the processor is further configured to:
in response to the drive component being in an operating mode of returning braking energy to a power source of the electric mobile device at the current time, determine the control output quantity of the drive component at the next time under the braking condition based on a control output quantity error of the drive component, wherein the control output quantity error is a difference between a current control output quantity of the drive component and a target control output quantity of the drive component; and
in response to the drive component not being in the operating mode of returning braking energy to the power source of the electric mobile device at the current time, determine the control output quantity of the drive component at the next time under the braking condition based on a braking reference value.

4. The control device according to claim 3, wherein the braking reference value includes an actual acceleration of the electric mobile device at the current time; and the processor is further configured to:
determine an acceleration of the control output quantity of the drive component under the braking condition based on the actual acceleration of the electric mobile device at the current time; and
determine a sum of the acceleration of the control output quantity of the drive component under the braking condition and the current control output quantity of the drive component as the control output quantity of the drive component at the next time under the braking condition.

5. The control device according to claim 3, wherein the operational data further includes an actual rotation speed of the drive component; and the processor is further configured to:
determine a distance variation value of the electric mobile device under the braking condition based on the actual rotation speed of the drive component, wherein the braking reference value includes the distance variation value;
determine an acceleration of the control output quantity of the drive component under the braking condition based on the distance variation value; and
determine a sum of the acceleration of the control output quantity of the drive component under the braking condition and the current control output quantity of the drive component as the control output quantity of the drive component at the next time under the braking condition.

6. The control device according to claim 2, wherein the operational data includes an actual output torque of the drive component, an actual input voltage of the drive component, a target speed of the electric mobile device, and an actual rotation speed of the drive component; the second operation condition includes a coasting condition; and
the processor is further configured to:
determine a target input voltage required for the actual output torque of the drive component based on the actual output torque of the drive component; and
in response to the target input voltage being greater than the actual input voltage of the drive component, determine that the operation condition estimation of the electric mobile device is the coasting condition; or
the processor is further configured to:
in response to the target speed of the electric mobile device and the actual rotation speed of the drive component having different directions, determine that the operation condition estimation of the electric mobile device is the coasting condition.

7. The control device according to claim 6, wherein the reference data includes a coasting reference value, wherein the coasting reference value includes the actual output torque of the drive component; and the processor is further configured to:
determine a target input voltage required for the actual output torque of the drive component based on the actual output torque of the drive component;
determine an acceleration of the control output quantity of the drive component under the coasting condition based on a difference between the target input voltage and an actual input voltage corresponding to the current control output quantity of the drive component; and
determine a sum of the acceleration of the control output quantity of the drive component under the coasting condition and the current control output quantity of the drive component as the control output quantity of the drive component at the next time under the coasting condition.

8. The control device according to claim 2, wherein the operational data includes at least two of a target speed of the electric mobile device, an actual output torque of the drive component, and an actual rotation speed of the drive component; the second operation condition includes an overspeed condition; and
the processor is further configured to:
in response to the actual output torque of the drive component and the actual rotation speed of the drive component having different directions, determine that the operation condition estimation of the electric mobile device is the overspeed condition; or
in response to the target speed of the electric mobile device and the actual rotation speed of the drive component having a same direction, determine that the operation condition estimation of the electric mobile device is the overspeed condition.

9. The control device according to claim 8, wherein the reference data includes an overspeed reference value, wherein the overspeed reference value includes the actual output torque of the drive component; and the processor is further configured to:
determine a target input voltage required for the actual output torque of the drive component based on the actual output torque of the drive component;
determine an acceleration of the control output quantity of the drive component under the overspeed condition based on a difference between the target input voltage and an actual input voltage corresponding to the current control output quantity of the drive component; and
determine a sum of the acceleration of the control output quantity of the drive component under the overspeed condition and the current control output quantity of the drive component as the control output quantity of the drive component at the next time under the overspeed condition.

10. The control device according to claim 8, wherein the overspeed reference value further includes a current overspeed value of the electric mobile device; and the processor is further configured to:
determine an acceleration of the control output quantity of the drive component under the overspeed condition based on the current overspeed value of the electric mobile device; and
determine a sum of the acceleration of the control output quantity of the drive component under the overspeed condition and the current control output quantity of the drive component as the control output quantity of the drive component at the next time under the overspeed condition.

11. The control device according to claim 2, wherein the operational data includes at least two of a target speed of the electric mobile device, an actual output torque of the drive component, and an actual rotation speed of the drive component; the second operation condition includes a free deceleration condition; and
the processor is further configured to:
in response to the actual output torque of the drive component and the actual rotation speed of the drive component having a same direction, determine that the operation condition estimation of the electric mobile device is the free deceleration condition; or,
in response to the target speed of the electric mobile device and the actual rotation speed of the drive component having a same direction, determine that the operation condition estimation of the electric mobile device is the free deceleration condition.

12. The control device according to claim 11, wherein the reference data includes a free deceleration reference value, wherein the free deceleration reference value includes a control output quantity error of the drive component; and the processor is further configured to:
determine an acceleration of the control output quantity of the drive component under the free deceleration condition based on the control output quantity error of the drive component, wherein the control output quantity error is a difference between a current control output quantity of the drive component and a target control output quantity of the drive component; and
determine a sum of the acceleration of the control output quantity of the drive component under the free deceleration condition and the current control output quantity of the drive component as the control output quantity of the drive component at the next time under the free deceleration condition.

13. The control device according to claim 11, wherein the free deceleration reference value further includes a difference between the actual rotation speed of the drive component and the target speed of the electric mobile device; and the processor is further configured to:
determine an acceleration of the control output quantity of the drive component under the free deceleration condition based on the difference between the actual rotation speed of the drive component and the target speed of the electric mobile device; and
determine a sum of the acceleration of the control output quantity of the drive component under the free deceleration condition and the current control output quantity of the drive component as the control output quantity of the drive component at the next time under the free deceleration condition.

14. The control device according to claim 2, wherein the second operation condition includes a normal driving condition; the reference data includes a normal driving reference value, wherein the normal driving reference value includes a control output quantity error of the drive component; and
the processor is further configured to:
determine an acceleration of the control output quantity of the drive component under the normal driving condition based on the control output quantity error of the drive component, wherein the control output quantity error is a difference between a current control output quantity of the drive component and a target control output quantity of the drive component; and
determine a sum of the acceleration of the control output quantity of the drive component under the normal driving condition and the current control output quantity of the drive component as the control output quantity of the drive component at the next time under the normal driving condition.

15. The control device according to claim 1, wherein
the operational data includes an inclination angle of the electric mobile device relative to a horizontal road surface; the operation condition estimation includes a third operation condition, wherein the third operation condition includes a first slope condition, a second slope condition, or a third slope condition; and
the processor is further configured to:
in response to the inclination angle being less than a first angle threshold, determine that the operation condition estimation of the electric mobile device is the first slope condition;
in response to the inclination angle remaining greater than a second angle threshold and less than a third angle threshold for a first accumulated time exceeding a first time threshold, determine that the operation condition estimation of the electric mobile device is the second slope condition; and
in response to the inclination angle remaining greater than the third angle threshold for a second accumulated time exceeding a second time threshold, determine that the operation condition estimation of the electric mobile device is the third slope condition,; wherein
a hazard level of the second slope condition is higher than a hazard level of the first slope condition, and a hazard level of the third slope condition is higher than the hazard level of the second slope condition.

16. The control device according to claim 15, wherein the processor is further configured to determine the target control strategy including deactivating a voice broadcast device of the electric mobile device for the first slope condition;
determine the target control strategy including controlling the voice broadcast device to issue a safety reminder for the second slope condition;
determine the target control strategy including controlling the electric mobile device to decelerate for the third slope device, wherein
a hazard level of the second slope condition is higher than a hazard level of the first slope condition, and a hazard level of the third slope condition is higher than the hazard level of the second slope condition.

17. The control device according to claim 1, wherein the operational data includes an actual linear speed and an actual angular speed of the electric mobile device; the operation condition estimation includes a fourth operation condition, wherein the fourth operation condition includes a turning overspeed condition; and
the processor is further configured to:
determine a turning radius of the electric mobile device based on the actual linear speed and the actual angular speed of the electric mobile device;
determine a maximum linear speed of the electric mobile device based on the turning radius; and
in response to the actual linear speed being greater than the maximum linear speed, determine that the operation condition estimation of the electric mobile device is the turning overspeed condition, and determine the target control strategy including controlling the electric mobile device to reduce the actual linear speed to below the maximum linear speed.

18. The control device according to claim 17, wherein the processor is further configured to:
determine the maximum linear speed of the electric mobile device based on a preset centrifugal acceleration and the turning radius; and
determine the actual linear speed of the electric mobile device based on acceleration information of the electric mobile device, the actual angular speed of the electric mobile device, a rotation speed of a drive component of the electric mobile device, a reduction ratio, and a wheel diameter parameter of the electric mobile device.

19. A control device for slope safety reminder of an electric mobile device, wherein the electric mobile device comprises a measurement unit, a voice broadcast device, and a processor, wherein the measurement unit and the voice broadcast device are electrically connected to the processor; and
the processor is configured to:
acquire operational data of the electric mobile device via the measurement unit; determine an inclination angle of the electric mobile device based on the operational data;
in response to the inclination angle being less than a first angle threshold, deactivate a reminder of the voice broadcast device, clear a first accumulated time and a second accumulated time, and continue acquiring the operational data of the electric mobile device via the measurement unit to determine the inclination angle of the electric mobile device;
in response to the inclination angle being greater than the first angle threshold and less than a second angle threshold, continue acquiring the operational data of the electric mobile device via the measurement unit to determine the inclination angle of the electric mobile device;
in response to the inclination angle being greater than the second angle threshold and less than a third angle threshold, and the first accumulated time being less than a set time, increment the first accumulated time by 1, and continue acquiring the operational data of the electric mobile device via the measurement unit to determine the inclination angle of the electric mobile device;
in response to the inclination angle being greater than the second angle threshold and less than the third angle threshold, and the first accumulated time being greater than the set time, activate the voice broadcast device to issue a reminder;
in response to the inclination angle being greater than the third angle threshold, and the second accumulated time being less than the set time, increment the second accumulated time by 1, and continue acquiring the operational data of the electric mobile device via the measurement unit to determine the inclination angle of the electric mobile device; and
in response to the inclination angle being greater than the third angle threshold, and the second accumulated time being greater than the set time, control the electric mobile device to decelerate to a stop.

20. A control device for intelligent turning deceleration of an electric mobile device, wherein the electric mobile device comprises a measurement unit and a processor, the measurement unit is electrically connected to the processor; and the processor is configured to:
acquire operational data of the electric mobile device via the measurement unit, and determine an actual linear speed and an actual angular speed of the electric mobile device based on the operational data;
determine a turning radius of the electric mobile device based on the actual linear speed and the actual angular speed of the electric mobile device;
determine a maximum linear speed of the electric mobile device based on the turning radius;
in response to the actual linear speed of the electric mobile device being less than the maximum linear speed, return to acquiring the operational data of the electric mobile device via the measurement unit to determine the actual linear speed and the actual angular speed of the electric mobile device; and
in response to the actual linear speed of the electric mobile device being greater than the maximum linear speed, control the electric mobile device to reduce the actual linear speed to below the maximum linear speed.
